(19) United States
(12) Patent Application Publication
(10) Pub. No.: US 2026/0031916 A1
(43) Pub. Date: Jan. 29, 2026

(54) SENSING METHOD AND APPARATUS

(71) Applicant: HUAWEI TECHNOLOGIES CO., LTD., Shenzhen (CN)

(72) Inventor: Zhongfeng Li, Shanghai (CN)

(21) Appl. No.: 19/342,951

(22) Filed: Sep. 29, 2025

Related U.S. Application Data
(63) Continuation of application No. PCT/CN2023/085661, filed on Mar. 31, 2023.

(51) Int. Cl. H04B 17/309; H04L 5/00; H04L 27/26; H04W 72/044

(52) U.S. Cl. CPC H04B 17/309; H04L 5/0026; H04L 27/2678; H04W 72/044

(57) ABSTRACT

This application relates to the field of communication technologies, and in particular, to a sensing method and an apparatus, to integrate sensing and communication, so as to reduce a sensing delay, support more refined and flexible interference avoidance, and improve sensing performance. The method includes: A first communication apparatus sends first information and a first sensing signal, where the first information includes configuration information of the first sensing signal; and the first communication apparatus receives a first measurement result, where the first measurement result is determined based on the first sensing signal, and the first measurement result is used for sensing.

### CROSS-REFERENCE TO RELATED APPLICATIONS

This application is a continuation of International Application No. PCT/CN2023/085661, filed on Mar. 31, 2023, the disclosure of which is hereby incorporated by reference in its entirety.

### TECHNICAL FIELD

Embodiments of this application relate to the field of communication technologies, and in particular, to a sensing method and an apparatus.

### BACKGROUND

With large-scale popularization of internet applications and wireless network devices, people's requirements for wireless communication further increase. In addition to increasing spectrum to improve communication capacity, density of communication nodes in a network can also be increased, to meet further requirements for communication coverage, delays, capacity, energy consumption, and the like. Therefore, the 3rd Generation Partnership Project (3GPP) introduces a relay node on a network side to support multi-hop transmission from a source to a destination terminal device. For example, in a 5th generation (5G) mobile communication system phase, an integrated access and backhaul (IAB) and a network-controlled repeater are introduced. In addition, on a terminal device side, sidelink communication of device to device (D2D) and vehicle to everything (V2X) is introduced to support direct communication between terminal devices. With evolution and development of communication technologies, wireless sensing and wireless communication begin to converge. This integration enables a communication system or a communication-assisted sensing system to provide various new services, such as high-precision positioning, environment reconstruction, and gesture and motion recognition. Sensing and communication can also assist each other to enhance mutual performance.

Currently, a communication-assisted sensing solution is to define a radar frame for sensing and a data frame for communication, where frame header control information indicates a frame type, that is, indicates a radar frame or a data frame, and a periodic preamble is used to follow a radar frame or a data frame to indicate radar transmission or data transmission, so as to distinguish radar frames or data frames transmitted between different devices, thereby avoiding interference between devices.

However, in this solution, resources for radar frame transmission are independent of resources for communication, and the use of time division multiplexing and the reuse of existing radar sensing technology of sharing only a similar preamble with a communication frame to avoid interference from other devices brings a large delay, poor interference avoidance effect, and inferior sensing performance.

### SUMMARY

Embodiments of this application provide a sensing method and an apparatus, to integrate sensing and communication, so as to reduce a sensing delay, support more refined and flexible interference avoidance, and improve sensing performance.

According to a first aspect, an embodiment of this application provides a sensing method. The method includes: A first communication apparatus sends first information and a first sensing signal, where the first information includes configuration information of the first sensing signal; and the first communication apparatus receives a first measurement result, where the first measurement result is determined based on the first sensing signal, and the first measurement result is used for sensing.

In the foregoing sensing method, the first communication apparatus may be a terminal device, a component (for example, a processor, a chip, or a chip system) of the terminal device, an apparatus that matches the terminal device, or the like. The first communication apparatus may send or receive information or a signal by using a sidelink or the like.

Compared with a solution in which communication and sensing are performed in a time division multiplexing manner, interference avoidance is performed only by using a preamble, and a sending apparatus performs self-sensing based on an echo signal, in this embodiment of this application, the first information including the configuration information of the first sensing signal and the associated first sensing signal may be transmitted together without a need of separately transmitting communication and sensing signals or channels, thereby reducing a sensing delay, and the first sensing signal can be configured at a finer granularity by transmitting the configuration information of the first sensing signal, for example, a time domain resource, a frequency domain resource, and the like of the first sensing signal are specifically configured, thereby helping a collaborative sensing apparatus (for example, a second communication apparatus) of the first communication apparatus receive the first sensing signal, avoiding blind detection on the first sensing signal, improving quality of receiving the first sensing signal, and improving sensing performance. In addition, the configuration information of the first sensing signal is transmitted, so that a non-collaborative sensing apparatus of the first communication apparatus can also learn of the configuration information of the first sensing signal, to avoid sending a sensing signal and/or data on a same resource as the first sensing signal. This also helps improve quality of receiving the first sensing signal by the collaborative sensing apparatus (for example, the second communication apparatus) of the first communication apparatus.

In a possible design, the configuration information of the first sensing signal includes resource configuration information of the first sensing signal and/or sensing priority or priority configuration information of the first sensing signal. Optionally, the resource configuration information of the first sensing signal includes one or more of the following: a beam relationship between the first sensing signal and a reference signal of a channel carrying the first information, an angle relationship between the first sensing signal and the reference signal corresponding to the channel carrying the first information, a quasi co-location (QCL) relationship between the first sensing signal and the reference signal of the channel carrying the first information, a subcarrier spacing configuration of the first sensing signal, a cyclic prefix (CP) configuration of the first sensing signal, a time domain resource configuration of the first sensing signal, and a frequency domain resource configuration of the first sensing signal.

The foregoing design helps the collaborative sensing apparatus of the first communication apparatus learn of a configuration of the first sensing signal, thereby improving quality of receiving and measuring the first sensing signal.

In a possible design, a time domain location of a first channel resource carrying the first information is earlier than a time domain location of a first signal resource carrying the first sensing signal, and/or a frequency domain resource length of the first channel resource carrying the first information is less than or equal to a frequency domain resource length of the first signal resource carrying the first sensing signal.

In the foregoing design, the time domain location of the first channel resource carrying the first information is earlier than the time domain location of the first signal resource carrying the first sensing signal, so that a communication apparatus other than the first communication apparatus can obtain, before the first sensing signal, the configuration information of the first sensing signal that is carried in the first information, to perform interference avoidance or avoid blind detection on the first sensing signal. The frequency domain resource length of the first channel resource carrying the first information may be less than or equal to the frequency domain resource length of the first signal resource carrying the first sensing signal, and this configuration may be used to transmit the first sensing signal with a larger bandwidth. This helps improve sensing performance.

In a possible design, the first information further includes configuration information of a second channel resource, and the second channel resource is used for transmission of second information and/or third information, where the second information includes a measurement method and/or a measurement requirement for measuring the first sensing signal, the third information includes a measurement feedback configuration, and the measurement feedback configuration indicates a configuration for transmission of the first measurement result. Optionally, the measurement feedback configuration includes one or more of the following: a time domain resource range configuration for a measurement feedback, a frequency domain resource range configuration for a measurement feedback, and a measurement feedback content configuration.

In the foregoing design, the first communication apparatus may further send the second information including the measurement method and/or the like and/or the third information including the measurement feedback configuration, to help indicate a measurement and a feedback of the collaborative sensing communication apparatus. This improves sensing performance. In addition, the first information further includes configuration information of a channel resource used to transmit the second information and/or the third information, to help another communication apparatus to perform interference avoidance or avoid blind detection on the second information and/or the third information.

In a possible design, the third information further includes first indication information and/or second indication information, where the first indication information indicates a second communication apparatus whether to send a second sensing signal, and the second indication information indicates the second communication apparatus whether to perform a measurement feedback on an echo signal of the second sensing signal sent by the second communication apparatus; and the second communication apparatus is an apparatus for determining the first measurement result based on the first sensing signal. Optionally, the method further includes: The first communication apparatus receives a third measurement result, where the third measurement result is determined by the second communication apparatus based on the echo signal of the second sensing signal sent by the second communication apparatus, and the first measurement result and the third measurement result are used together for sensing.

In the foregoing design, the first communication apparatus may further obtain a result of measuring an echo signal of the second communication apparatus by the second communication apparatus. This helps further improve sensing performance.

In a possible design, the first information further includes configuration information of a third channel resource and/or third indication information, where the third channel resource is used for transmission of a second measurement result, the second measurement result is determined by the first communication apparatus based on an echo signal of the first sensing signal, and the third indication information indicates the first communication apparatus whether to send the second measurement result.

In the foregoing design, the first communication apparatus may further provide the collaborative sensing second communication apparatus or the like with the second measurement result determined based on the echo signal of the sensing signal of the first communication apparatus. This helps improve sensing precision.

In a possible design, the method further includes: The first communication apparatus receives first feedback information and the second sensing signal, where the first feedback information includes configuration information of the second sensing signal; and the first communication apparatus determines a fourth measurement result based on the second sensing signal, where the fourth measurement result and the first measurement result are used together for sensing.

In the foregoing design, the first communication apparatus may further measure the second sensing signal sent by the collaborative sensing second communication apparatus. This helps further improve sensing performance.

In a possible design, there is a QCL relationship between the first sensing signal and the reference signal of the channel carrying the first information; or there is a QCL relationship between the first sensing signal and a sub-beam of the reference signal of the channel carrying the first information.

In the foregoing design, a beam of the first sensing signal can be the same as a beam of the channel carrying the first information for repeated transmission or can be split into a narrow beam for transmission. This helps improve signal energy when the first sensing signal is received as a reflected signal, and improve measurement estimation performance. The first sensing signal having the same beam as the channel carrying the first information may be used as a demodulation reference signal for channel estimation, and a split narrow beam may also improve angle estimation resolution.

In a possible design, when an N-hop sensing signal measurement is performed, the third information further includes one or more of the following: a measurement hop count N, an N-hop measurement delay budget, and a current hop count, where N is greater than or equal to 2.

In the foregoing design, the third information carries information about the measurement hop count N, the N-hop measurement delay budget, and the current hop count. Therefore, when the N-hop sensing signal measurement is performed, a communication apparatus that measures a sensing signal determines whether the measurement of the sensing signal ends, and whether it is necessary to continue to send a sensing signal for a sensing signal measurement by a next-hop communication apparatus. For example, when the current hop count is equal to the measurement hop count N, the communication apparatus determines that the N-hop sensing signal measurement ends, and does not send a sensing signal for a sensing signal measurement by the next-hop communication apparatus; or when the current hop count is less than the measurement hop count N, determines that the N-hop sensing signal measurement does not end, and sends a sensing signal for a sensing signal measurement by the next-hop communication apparatus.

In a possible design, the method further includes: The first communication apparatus receives M fifth measurement results, where the first measurement result and the M fifth measurement results are used together for sensing. The first measurement result and the M fifth measurement results are determined by M+1 hop apparatuses; a measurement result determined by a P^{th}-hop apparatus in the M+1 hop apparatuses is determined based on a sensing signal sent by a (P−1)^{th}-hop apparatus, where P is greater than or equal to 2 and is less than or equal to M; and the first measurement result is determined by a first-hop apparatus in the M+1 hop apparatuses based on the first sensing signal sent by the first communication apparatus, where M is less than or equal to N.

In addition, it should be understood that, during multi-hop apparatus based sensing, a measurement result sent by each hop apparatus in the M+1 hop apparatuses is not limited to a measurement result (referred to as a measurement result A below) determined based on a sensing signal sent by a previous-hop apparatus, and may further include a measurement result (referred to as a measurement result B below) determined based on an echo signal of a sensing signal sent by the hop apparatus. Some or all of measurement results A and measurement results B sent by the M+1 hop apparatuses may be used for sensing.

In the foregoing design, sensing may be performed based on a multi-hop measurement result. This helps improve sensing precision.

In a possible design, a subcarrier spacing of the first sensing signal is 15*2\hat{ }n kilohertz (kHz), and a CP time ratio corresponding to the first sensing signal is 2/15; or a subcarrier spacing of the first sensing signal is (15+1)*2\hat{ }n kHz, and a cyclic prefix CP time ratio corresponding to the first sensing signal is 2/16, where n is an integer greater than or equal to 0.

In the foregoing design, a CP size can be extended, so that multipath interference caused by a reflection path is further reduced.

In a possible design, the first information further includes duration, that is configured based on a beam, of monitoring on a beam carrying the first sensing signal. The monitoring duration may be determined based on one or more of the following: a measurement performance requirement of the beam carrying the first signal; an indication by the second communication apparatus for measurement duration of the beam carrying the first signal; a load on the beam carrying the first signal; and sending information for the first signal within specified duration on the beam carrying the first signal.

In the foregoing design, monitoring duration may be independently configured for each beam, so that the monitoring duration can be flexibly configured based on a status of each beam. This helps improve sensing efficiency and reduce a sensing delay.

In a possible design, the method further includes: The first communication apparatus receives second feedback information, where the second feedback information indicates feedback content corresponding to the first measurement result, for example, a corresponding measurement quantity/measurement method.

In the foregoing design, when the first communication apparatus and a communication apparatus that measures the first sensing signal do not negotiate a measurement quantity/measurement method for measuring the first sensing signal, a communication apparatus (for example, the second communication apparatus) that measures the first sensing signal to determine the first measurement result may further indicate, by using the second feedback information, the feedback content corresponding to the first measurement result, for example, the measurement quantity/measurement method corresponding to the first measurement result. This helps the first communication apparatus learn of content included in the first measurement result.

According to a second aspect, an embodiment of this application provides a sensing method. The method includes: A second communication apparatus receives first information and a first sensing signal, where the first information includes configuration information of the first sensing signal; the second communication apparatus determines a first measurement result based on the first sensing signal; and the second communication apparatus sends the first measurement result.

In the foregoing sensing method, the second communication apparatus may be a terminal device, a component (for example, a processor, a chip, or a chip system) of the terminal device, an apparatus that matches the terminal device, or the like. The second communication apparatus may send or receive information or a signal by using a sidelink or the like.

In a possible design, the configuration information of the first sensing signal includes resource configuration information of the first sensing signal and/or sensing priority configuration information of the first sensing signal.

In a possible design, the resource configuration information of the first sensing signal includes one or more of the following: a beam relationship between the first sensing signal and a reference signal of a channel carrying the first information, an angle relationship between the first sensing signal and the reference signal corresponding to the channel carrying the first information, a QCL relationship between the first sensing signal and the reference signal of the channel carrying the first information, a subcarrier spacing configuration of the first sensing signal, a CP configuration of the first sensing signal, a time domain resource configuration of the first sensing signal, and a frequency domain resource configuration of the first sensing signal.

In a possible design, a time domain location of a first channel resource carrying the first information is earlier than a time domain location of a first signal resource carrying the first sensing signal, and/or a frequency domain resource length of the first channel resource carrying the first information is less than or equal to a frequency domain resource length of the first signal resource carrying the first sensing signal.

In a possible design, the first information further includes configuration information of a second channel resource, and the second channel resource is used for transmission of second information and/or third information, where the second information includes a measurement method and/or a measurement requirement for measuring the first sensing signal, the third information includes a measurement feedback configuration, and the measurement feedback configuration indicates a configuration for transmission of the first measurement result. When the second communication apparatus receives the second information on the second channel resource, that the second communication apparatus determines the first measurement result based on the first sensing signal includes: The second communication apparatus determines the first measurement result based on the second information and the first sensing signal. When the second communication apparatus receives the third information on the second channel resource, that the second communication apparatus sends the first measurement result includes: The second communication apparatus sends the first measurement result based on the third information.

In a possible design, the measurement feedback configuration includes one or more of the following: a time domain resource range configuration for a measurement feedback, a frequency domain resource range configuration for a measurement feedback, and a measurement feedback content configuration.

In a possible design, the method further includes: The second communication apparatus receives a second measurement result on a third channel resource, where the second measurement result is determined, based on an echo signal of the first sensing signal, by a first communication apparatus that sends the first sensing signal. That the second communication apparatus determines the first measurement result based on the first sensing signal includes: The second communication apparatus determines the first measurement result based on the first sensing signal and the second measurement result.

In a possible design, the first information further includes configuration information of the third channel resource and/or third indication information, and the third indication information indicates the first communication apparatus whether to send the second measurement result.

In a possible design, the third information further includes first indication information, and the first indication information indicates the second communication apparatus whether to send a second sensing signal; and the method further includes: When the first indication information indicates the second communication apparatus to send the second sensing signal, the second communication apparatus sends first feedback information and the second sensing signal, where the first feedback information includes configuration information of the second sensing signal.

In a possible design, the third information further includes second indication information, and the second indication information indicates the second communication apparatus whether to perform a measurement feedback on an echo signal of the second sensing signal sent by the second communication apparatus; and the method further includes: When the second indication information indicates the second communication apparatus to perform the measurement feedback on the echo signal of the second sensing signal sent by the second communication apparatus, the second communication apparatus sends a third measurement result, where the third measurement result is determined by the second communication apparatus based on the echo signal of the second sensing signal sent by the second communication apparatus.

In a possible design, there is a QCL relationship between the first sensing signal and the reference signal of the channel carrying the first information; or there is a QCL relationship between the first sensing signal and a sub-beam of the reference signal of the channel carrying the first information.

In a possible design, when an N-hop sensing signal measurement is performed, the third information further includes one or more of the following: a measurement hop count N, an N-hop measurement delay budget, and a current hop count, where N is greater than or equal to 2. The second communication apparatus determines a next-hop measurement feedback configuration based on the third information.

In a possible design, a subcarrier spacing of the first sensing signal is 15*2\hat{ }n kHz, and a CP time ratio corresponding to the first sensing signal is 2/15; or a subcarrier spacing of the first sensing signal is (15+1)*2\hat{ }n kHz, and a CP time ratio corresponding to the first sensing signal is 2/16, where n is an integer greater than or equal to 0.

In a possible design, the first information further includes duration of monitoring on a beam carrying the first sensing signal.

In a possible design, the method further includes: The second communication apparatus sends second feedback information, where the fifth information indicates feedback content corresponding to the first measurement result.

According to a third aspect, an embodiment of this application provides a first communication apparatus. The first communication apparatus may be used in the communication apparatus in the first aspect. The first communication apparatus may be a terminal device, a component (for example, a processor, a chip, or a chip system) of the terminal device, an apparatus that matches the terminal device, or the like.

In a possible implementation, the first communication apparatus may include a module or unit in one-to-one correspondence with the method/operation/step/action described in the first aspect, for example, a processing unit and an interface unit. The module or unit may be a hardware circuit, or may be software, or may be implemented by a hardware circuit in combination with software.

According to a fourth aspect, an embodiment of this application provides a second communication apparatus. The second communication apparatus may be used in the communication apparatus in the second aspect. The second communication apparatus may be a terminal device, a component (for example, a processor, a chip, or a chip system) of the terminal device, an apparatus that matches the terminal device, or the like.

In a possible implementation, the second communication apparatus may include a module or unit in one-to-one correspondence with the method/operation/step/action described in the second aspect, for example, a processing unit and an interface unit. The module or unit may be a hardware circuit, or may be software, or may be implemented by a hardware circuit in combination with software.

According to a fifth aspect, an embodiment of this application provides a communication apparatus. The communication apparatus includes an interface circuit and a processor, and the processor and the interface circuit are coupled to each other. The processor is configured to implement the method according to the first aspect or the second aspect by using a logic circuit or by executing instructions. The interface circuit is configured to: receive a signal from a communication apparatus other than the communication apparatus and transmit the signal to the processor, or send a signal from the processor to a communication apparatus other than the communication apparatus. It may be understood that the interface circuit may be a transceiver, a transceiver machine, or an input/output interface.

Optionally, the communication apparatus may further include a memory, configured to store instructions executed by the processor, or store input data required by the processor to run the instructions, or store data generated after the processor runs the instructions. The memory may be a physically independent unit, or may be coupled to the processor, or the processor includes the memory.

According to a sixth aspect, an embodiment of this application provides a computer-readable storage medium. The computer-readable storage medium stores a computer program or instructions, and when the computer program or the instructions are executed by a processor, the method according to the first aspect or the second aspect can be implemented.

According to a seventh aspect, an embodiment of this application further provides a computer program product, including a computer program or instructions. When the computer program or the instructions are executed by a processor, the method according to the first aspect or the second aspect can be implemented.

According to an eighth aspect, an embodiment of this application further provides a chip system. The chip system includes a processor, the processor is configured to be coupled to a memory, the memory is configured to store a program or instructions, and when the program or the instructions are executed by the processor, the method according to the first aspect or the second aspect can be implemented.

According to a ninth aspect, an embodiment of this application further provides a communication system. The system may include the first communication apparatus in the first aspect and the second communication apparatus in the second aspect.

For technical effect that can be achieved in the second aspect to the ninth aspect, refer to the technical effect that can be achieved in the first aspect. Details are not described herein again.

### BRIEF DESCRIPTION OF DRAWINGS

FIG. 1 is a diagram of an architecture of a communication system according to an embodiment of this application;

FIG. 2 is a diagram of a distributed control network according to an embodiment of this application;

FIG. 3 is a diagram of a centralized control network according to an embodiment of this application;

FIG. 4 is a diagram of a sensing method according to an embodiment of this application;

FIG. 5 is a diagram 1 of a sensing measurement according to an embodiment of this application;

FIG. 6 is a diagram 2 of a sensing measurement according to an embodiment of this application;

FIG. 7 is a diagram 3 of a sensing measurement according to an embodiment of this application;

FIG. 8 is a diagram of a time-based measurement according to an embodiment of this application;

FIG. 9 is a diagram 1 of a sensing block according to an embodiment of this application;

FIG. 10 is a diagram 2 of a sensing block according to an embodiment of this application;

FIG. 11 is a diagram 1 of a sensing procedure according to an embodiment of this application;

FIG. 12 is a diagram 1 of a sensing block that is sent and fed back according to an embodiment of this application;

FIG. 13 is a diagram 2 of a sensing procedure according to an embodiment of this application;

FIG. 14 is a diagram 2 of a sensing block that is sent and fed back according to an embodiment of this application;

FIG. 15 is a diagram 3 of a sensing block that is sent and fed back according to an embodiment of this application;

FIG. 16 is a diagram of a multi-hop sensing procedure according to an embodiment of this application;

FIG. 17 is a diagram 4 of a sensing block that is sent and fed back according to an embodiment of this application;

FIG. 18 is a diagram 5 of a sensing block that is sent and fed back according to an embodiment of this application;

FIG. 19 is a diagram of measuring a sensing signal of an object falling according to an embodiment of this application;

FIG. 20 is a diagram of a distance change of a potential sensing target T with time according to an embodiment of this application;

FIG. 21 is a diagram 1 of boundaries of symbols of different subcarrier spacings according to an embodiment of this application;

FIG. 22 is a diagram 2 of boundaries of symbols of different subcarrier spacings according to an embodiment of this application;

FIG. 23 is a diagram of overlapping between a sensing block and a synchronization block according to an embodiment of this application;

FIG. 24 is a diagram 1 of a structure of a communication apparatus according to an embodiment of this application; and

FIG. 25 is a diagram 2 of a structure of a communication apparatus according to an embodiment of this application.

### DESCRIPTION OF EMBODIMENTS

Technical solutions in embodiments of this application may be applied to various communication systems, for example, a 4th generation (4G) mobile communication system such as a long term evolution (LTE) system, a 5th generation (5G) mobile communication system such as a new radio (NR) system, and a communication system evolved after 5G, for example, a 6th generation (6G) system. The communication system may alternatively be a device to device (D2D) network, a Wi-Fi network, a machine to machine (M2M) network, an internet of things (IoT) network, or another network.

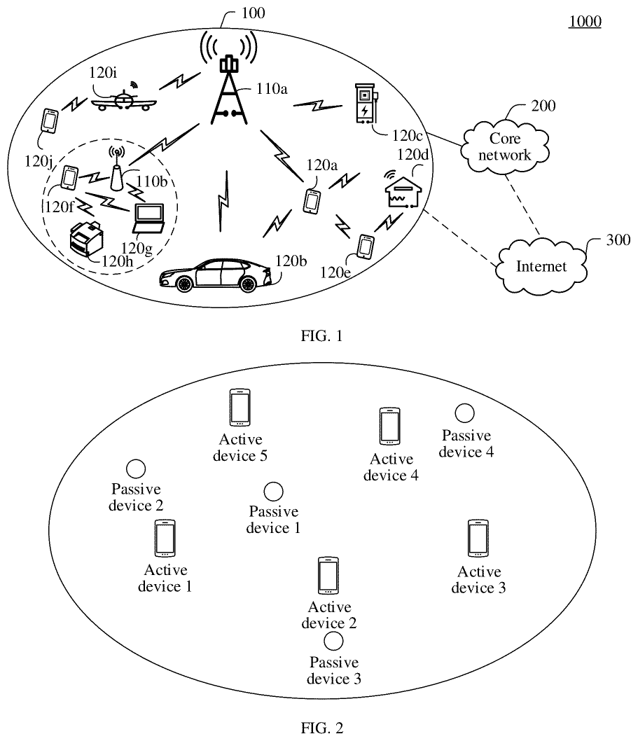

An architecture of a communication system to which embodiments of this application are applied may be shown in FIG. 1. The communication system 1000 includes a radio access network (RAN) 100 and a core network (CN) 200. Optionally, the communication system 1000 may further include the internet 300. The RAN 100 includes at least one network device (for example, 110a and 110b in FIG. 1, which are collectively referred to as 110) and at least one terminal device (for example, 120a to 120j in FIG. 1, which are collectively referred to as 120). The RAN 100 may further include another RAN node, for example, a wireless relay device and/or a wireless backhaul device (not shown in FIG. 1). The terminal device 120 is connected to the network device 110 in a wireless manner. The network device 110 is connected to the core network 200 in a wireless or wired manner. A core network device in the core network 200 and the network device 110 in the RAN 100 may respectively be different physical devices, or may be a same physical device that integrates a logical function of the core network and a logical function of the radio access network.

The RAN 100 may be a cellular system related to the 3rd Generation Partnership Project (3GPP), for example, a 4G system, a 5G system, or a system evolved after 5G (for example, a 6G mobile communication system). The RAN 100 may alternatively be an open radio access network (open RAN, O-RAN or ORAN), a cloud radio access network (CRAN), or a Wi-Fi system. The RAN 100 may alternatively be a communication system that integrates two or more of the foregoing systems.

An apparatus provided in embodiments of this application may be used in the network device 110 or the terminal device 120. It may be understood that FIG. 1 shows only a possible architecture of the communication system to which embodiments of this application may be applied. In another possible scenario, the architecture of the communication system may alternatively include another device.

The network device 110 is a node in a radio access network (RAN), and may also be referred to as an access network device or a RAN node (or device). The network device 110 is configured to help the terminal device implement wireless access. A plurality of network devices 110 in the communication system 1000 may be nodes of a same type, or may be nodes of different types. In some scenarios, roles of the network device 110 and the terminal device 120 are relative. For example, the network element 120i in FIG. 1 may be a helicopter or an unmanned aerial vehicle, and may be configured as a mobile base station. For the terminal device 120j that accesses the RAN 100 through the network element 120i, the network element 120i is a base station. However, for the base station 110a, the network element 120i is a terminal device. The network device 110 and the terminal device 120 are sometimes referred to as communication apparatuses. For example, the network elements 110a and 110b in FIG. 1 may be understood as communication apparatuses having a base station function, and the network elements 120a to 120j may be understood as communication apparatuses having a terminal device function.

In a possible scenario, the network device may be a base station, an evolved NodeB (eNodeB), a transmitting and receiving point (TRP), a transmitting point (TP), a next generation NodeB (gNB), a next generation base station in a 6G mobile communication system, a base station in a future mobile communication system, a satellite, an access point (AP) in a Wi-Fi system, an integrated access and backhaul (IAB) node, a network device that is in a non-terrestrial network (NTN) communication system of a mobile switching center and that may be deployed on a high-altitude platform or a satellite, or the like. The network device may be a macro base station (for example, 110a in FIG. 1), a micro base station or an indoor station (for example, 110b in FIG. 1), a relay node or a donor node, or a radio controller in a CRAN scenario. The network device may alternatively be a device having a base station function in device to device (D2D) communication, internet of vehicles communication, unmanned aerial vehicle communication, or machine communication. Optionally, the network device may alternatively be a server, a wearable device, a vehicle, a vehicle-mounted device, or the like. For example, an access network device in a vehicle to everything (vehicle to everything, V2X) technology may be a road side unit (RSU).

In another possible scenario, a plurality of network devices collaborate to assist the terminal device in implementing wireless access, and different network devices implement some base station functions. For example, the network device may be a central unit (CU), a distributed unit (DU), a CU-control plane (CP), a CU-user plane (UP), or a radio unit (RU). The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as an example for description in this application. Any one of the CU (or the CU-CP and the CU-UP), the DU, and the RU in this application may be implemented by using a software module, a hardware module, or a combination of a software module and a hardware module.

A form of the network device is not limited in embodiments of this application. An apparatus for implementing a function of a network device may be a network device, or may be an apparatus, for example, a chip system, that can enable a network device to implement the function. The apparatus may be mounted in the network device or used in a manner of matching the network device.

The terminal device 120 may also be referred to as a terminal, user equipment (UE), a mobile station (MS), a mobile terminal (MT), or the like, or is a device that provides a user with voice or data connectivity, or may be an internet of things device. For example, the terminal device includes a handheld device, a vehicle-mounted device, or the like that has a wireless connection function. Currently, the terminal device may be: a mobile phone, a tablet computer, a notebook computer, a palmtop computer, a mobile internet device (MID), a wearable device (for example, a smartwatch, a smart band, or a pedometer), a vehicle-mounted device (for example, a vehicle, a bicycle, an electric vehicle, an airplane, a ship, a train, or a high-speed railway), a satellite terminal, a virtual reality (VR) device, an augmented reality (AR) device, a smart point of sale (POS) terminal, customer-premises equipment (CPE), a wireless terminal in industrial control, a smart home device (for example, a refrigerator, a television, an air conditioner, or an electricity meter), a smart robot, a robot arm, a workshop device, a wireless terminal in self-driving, a wireless terminal in telemedicine, a wireless terminal in a smart grid, a wireless terminal in transportation safety, a wireless terminal in a smart city, a wireless terminal in a smart home, a flight device (for example, a smart robot, a hot balloon, an unmanned aerial vehicle, or an airplane), or the like. The terminal device may alternatively be another device having a terminal function. For example, the terminal device may alternatively be a device having a terminal function in D2D communication.

A device form of the terminal device is not limited in embodiments of this application. An apparatus for implementing a function of a terminal device may be a terminal device, or may be an apparatus, for example, a chip system, that can enable a terminal device to implement the function. The apparatus may be mounted in the terminal device or used in a manner of matching the terminal device. In embodiments of this application, the chip system may include a chip, or may include a chip and another discrete component.

In some implementations, embodiments of this application may be applied to a scenario such as a distributed control network or a centralized control network.

A distributed control network shown in FIG. 2 is used as an example. The distributed control network shown in FIG. 2 may include active devices (active devices 1 to 5) and passive devices (such as passive devices 1 to 4). The active device may be a device that has a communication capability and can currently send and/or receive a communication signal, for example, a terminal device. The passive device may be a device that currently or inherently does not have a capability of sending and receiving a signal. Each device in the network is responsible for resource selection configurations, and management for sensing information (or data) including collection, calculation, and synthesis, sensing target determining, and the like. Instead of a centralized device performing configurations, a device in the distributed control network performs determining, for example, independent determining or determining with assistance of another device. In this distributed control network, an active device may be used for target sensing. It should be understood that target sensing herein may include but is not limited to identification, localization, posture identification, and the like of an active device and/or a passive device. In an example, in the distributed control network shown in FIG. 2, one or more of the active devices 1 to 5 implement sensing of the passive device 1.

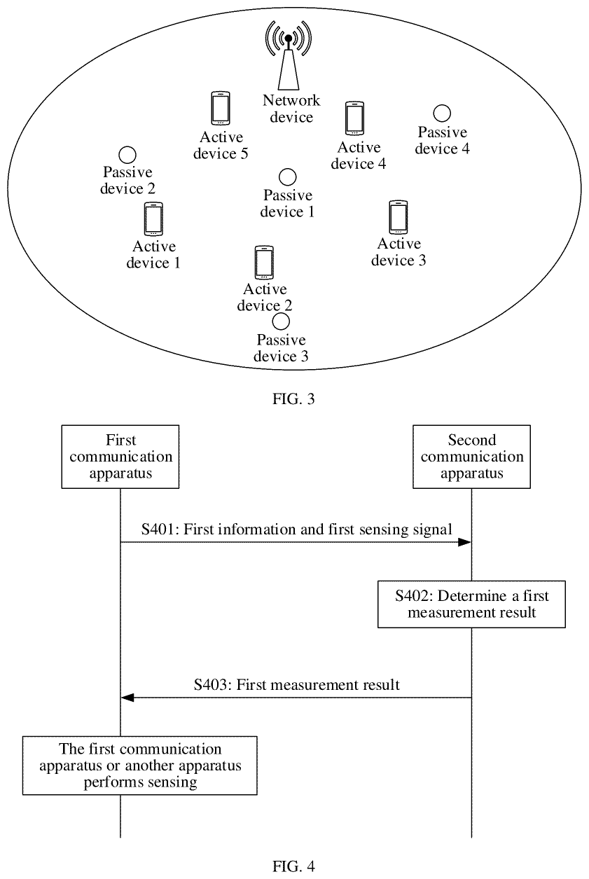

A centralized control network shown in FIG. 3 is used as an example. The centralized control network shown in FIG. 3 may include a centralized scheduling node (a network device is used as an example in FIG. 3), active devices (active devices 1 to 5) and passive devices (such as passive devices 1 to 4). A centralized control node in the centralized control network may be a network device or a device located in a core network, and is responsible for resource configurations, and management for sensing information (or data) including collection, calculation, and synthesis, sensing target determining, and the like. The centralized control node may also be responsible for a configuration of some resources, for example, a coarse-grained carrier and a bandwidth part (BWP), and a resource pool configuration. Resources of a finer granularity may be configured in a distributed manner by an active device or the like.

In a current communication-assisted sensing solution, a resource used for radar transmission is relatively independent of a resource used for communication, a time division multiplexing manner is used, and a radar sensing technology reuses an existing implementation, and shares only a similar preamble with a communication frame to avoid interference from another device. Consequently, a relatively large delay, poor interference avoidance effect, and poor sensing performance exist. In addition, a preamble-based indication is followed by limited indication information that can be provided by radar or communication data, and obtaining of a communication-assisted sensing measurement quantity or the like is not considered. Based on this, this application provides a sensing method and an apparatus, to integrate sensing and communication, so as to reduce a sensing delay, support more refined and flexible interference avoidance, and improve sensing performance. The following describes embodiments of this application in detail with reference to the accompanying drawings.

In addition, it should be understood that ordinal numbers such as “first” and “second” mentioned in embodiments of this application are used to distinguish between a plurality of objects, and are not intended to limit sizes, content, a sequence, a time sequence, priorities, importance degrees, or the like of the plurality of objects. For example, first information and second information do not indicate different priorities, importance degrees, or the like corresponding to the two pieces of information.

In embodiments of this application, unless otherwise specified, a quantity of nouns represents “a singular noun or a plural noun”, that is, “one or more”. In addition, “at least one” means one or more, and “a plurality of” means two or more. Moreover, “and/or” describes an association relationship between associated objects, and represents that three relationships may exist. For example, A and/or B may represent the following cases: Only A exists, both A and B exist, and only B exists, where A and B may be singular or plural. A character “/” generally indicates an “or” relationship between the associated objects. For example, A/B indicates A or B. In addition, “at least one of the following items (pieces)” or a similar expression thereof means any combination of these items, including any combination of singular items (pieces) or plural items (pieces). For example, at least one of a, b, or c indicates: a, b, c, a and b, a and c, b and c, or a, b, and c, where a, b, and c may be singular or plural.

FIG. 4 is a diagram of a sensing method according to an embodiment of this application. FIG. 4 shows the method by using an example in which the method is performed by a first communication apparatus and a second communication apparatus. The first communication apparatus may be a network device, a component (for example, a processor, a chip, or a chip system) of the network device, or an apparatus that matches the network device, and may be referred to as a first network apparatus in this case. Alternatively, the first communication apparatus may be a terminal device, a component (for example, a processor, a chip, or a chip system) of the terminal device, or an apparatus that matches the terminal device, and may be referred to as a first terminal apparatus in this case. The second communication apparatus may be a network device different from the first communication apparatus, a component (for example, a processor, a chip, or a chip system) of the network device, or an apparatus that matches the network device, and may be referred to as a second network apparatus in this case. Alternatively, the second communication apparatus may be a terminal device different from the first communication apparatus, a component (for example, a processor, a chip, or a chip system) of the terminal device, or an apparatus that matches the terminal device, and may be referred to as a second terminal apparatus in this case. The method includes the following steps.
S401: The first communication apparatus sends first information and a first sensing signal, and correspondingly the second communication apparatus receives the first information and the first sensing signal.

In a wireless sensing technology, a change of a wireless signal in a propagation process is analyzed, to obtain a characteristic of signal propagation space, thereby implement sensing of a sense. The signal propagation space may be used as a channel. The scene herein includes not only a moving target factor, for example, whether there is a moving target and a location, a direction, a posture, an action, or the like of the mobile target, but also a static target factor, for example, a building or a street. A basic principle of wireless sensing is similar to a principle of wireless communication, that is, a specific waveform signal is transmitted, and is received by a receiver after passing through a wireless channel. Therefore, the wireless communication and wireless sensing technologies may be integrated together, so that a surrounding environment is sensed while communication is implemented. In this embodiment of this application, sensing may be performed by using a signal in wireless communication. In other words, the first sensing signal may be a signal in wireless communication, for example, a pilot signal (the pilot signal may also be referred to as a reference signal). It should be understood that a pilot signal for implementing sensing may be any signal, provided that a sequence is known to both a transmitting end and a receiving end. For example, a reference signal for implementing sensing may be a channel state information reference signal (CSI-RS), a demodulation reference signal (DMRS), or the like. This is not limited in this application. In a possible implementation, the first sensing signal may be a signal dedicated to a sensing measurement. A sequence of the signal dedicated to a sensing measurement is known to the transmitting end and the receiving end, and may be negotiated by the transmitting end and the receiving end in advance, or may be preconfigured on the transmitting end and the receiving end. This is not limited in this application.

In this embodiment of this application, the first information may include configuration information of the first sensing signal. The first communication apparatus may transmit the first information together with the associated first sensing signal, for example, send the first information and the first sensing signal that are consecutive in time domain. A non-collaborative sensing communication apparatus of the first communication apparatus, for example, a communication apparatus that does not receive the first sensing signal or that is not configured to process the first sensing signal, may obtain the configuration information of the first sensing signal by receiving the first information, to perform interference avoidance, for example, avoid sending other data or another sensing signal on a resource occupied by the first sensing signal. A collaborative sensing communication apparatus of the first communication apparatus, for example, the second communication apparatus that receives the first sensing signal sent by the first communication apparatus and processes the first sensing signal, may obtain the configuration information of the first sensing signal by receiving the first information, and obtain a specific configuration of the first sensing signal, to avoid blind detection on the first sensing signal and improve performance of receiving the first sensing signal.

In a possible implementation, the configuration information of the first sensing signal may include resource configuration information of the first sensing signal and/or sensing priority configuration information of the first sensing signal. The resource configuration information of the first sensing signal may include one or more of the following: a space domain resource configuration, a time domain resource configuration, a frequency domain resource configuration, a subcarrier spacing configuration, a cyclic prefix (CP) configuration, and the like of the first sensing signal.

The space domain resource configuration may include one or more of the following: a beam relationship between the first sensing signal and a reference signal of a channel carrying the first information, an angle relationship between the first sensing signal and the reference signal corresponding to the channel carrying the first information, a quasi co-location (QCL) relationship between the first sensing signal and the reference signal of the channel carrying the first information, and the like.

In some implementations, the resource configuration may alternatively include one or more of the following: a beam relationship, an angle relationship, a QCL relationship, and another relationship between the first sensing signal and another preconfigured signal such as a synchronization signal (SS) or a channel state information reference signal (CSI-RS), and one or more of the following: a beam relationship, an angle relationship, a QCL relationship, and another relationship between the reference signal corresponding to the channel carrying the first information and the another preconfigured signal. Certainly, the resource configuration may alternatively include some or all of the foregoing relationship between the first sensing signal and the reference signal of the channel carrying the first information, the foregoing relationship between the first sensing signal and the another preconfigured signal, and the foregoing relationship between the reference signal corresponding to the channel carrying the first information and the another preconfigured signal. This is not limited in this application.

The beam relationship between the first sensing signal and the reference signal of the channel carrying the first information may also be referred to as a beam relationship between the first sensing signal and the channel carrying the first information, and may include a same-beam relationship or a sub-beam relationship. When the first sensing signal and the reference signal of the channel carrying the first information have a same beam, one or more beams for repeatedly transmitting the first sensing signal may be configured. A quantity of repetitions may be preconfigured. For example, the quantity of repetitions may be preconfigured in the first communication apparatus. Alternatively, the quantity of repetitions may be indicated by a network device. Alternatively, the quantity of repetitions may be selected from a preconfigured repetition quantity set or a repetition quantity set indicated by the network device. When the network device indicates the quantity of repetitions or the repetition quantity set, the quantity of repetitions or the repetition quantity set may be indicated by the network device by using higher layer signaling, and the higher layer signaling may be radio resource control (RRC) signaling, a medium access control control element (MAC CE), or the like.

When a beam of the first sensing signal is a sub-beam of the reference signal of the channel carrying the first information, more than one sub-beam may be configured to transmit the first sensing signal. Some or all sub-beam angles of the first sensing signal are within a beam angle range of the reference signal of the channel carrying the first information. A quantity of sub-beams may be selected and configured from a preconfigured sub-beam quantity set or a sub-beam quantity set configured by using higher layer signaling. In the foregoing implementation, a beam of the sensing signal can be the same as a beam of the reference signal of the channel carrying the first information for repeated transmission or can be split into a narrow beam for sub-beam transmission. This helps improve signal quality when the first sensing signal is received as a reflected signal. The first sensing signal having the same beam as the reference signal of the channel carrying the first information may alternatively be used as a demodulation reference signal for channel estimation, and is used for receiving the first information and the like.

The QCL relationship between the first sensing signal and the reference signal of the channel carrying the first information may indicate a large-scale parameter relationship between the first sensing signal and the reference signal of the channel carrying the first information. After receiving the relationship, the receiving end (for example, the second communication apparatus) can simplify receiving processing, thereby reducing a processing delay. For example, when the first sensing signal and the reference signal of the channel carrying the first information have a same beam, it may indicate that there is a QCL relationship about a large-scale parameter delay spread, a Doppler shift, an average channel gain, an average delay, and a spatial parameter between the first sensing signal and the reference signal of the channel carrying the first information. Alternatively, the foregoing QCL relationship may implicitly indicate that the first sensing signal and the reference signal of the channel carrying the first information use a same beam, so that the receiving end can perform channel estimation only once, thereby simplifying receiving processing. When the beam of the first sensing signal is a split narrow beam or a sub-beam relative to the beam of the reference signal of the channel carrying the first information, it may also indicate that the first sensing signal has a QCL relationship with a preconfigured SS or CSI-RS, thereby simplifying receiving processing. Sensing signal transmission is performed by using a narrower sub-beam, so that a smaller sensing amount in an angle direction can be obtained, thereby improving resolution of performing angle estimation by using the first sensing signal. In addition, a narrow beam also helps aggregate energy in a narrower direction, thereby improving signal received energy. For a sub-beam, a quantity of repetitions of the sub-beam may also be configured, to further improve performance of receiving the first sensing signal.

Similarly, if the configuration information of the first sensing signal directly includes the angle relationship between the first sensing signal and the reference signal corresponding to the channel carrying the first information, the second communication apparatus may also simplify processing, to improve resolution of performing angle estimation by using the first sensing signal.

In a possible implementation, a time domain resource may include one or more of the following: a symbol configuration, start time, a period, and the like corresponding to the first sensing signal in time domain; and a frequency domain resource may include one or more of the following: a physical resource block configuration, a BWP configuration, a carrier configuration, and the like corresponding to the first sensing signal. This implementation can prevent the receiving end of the first sensing signal (for example, the second communication apparatus) from performing blind detection on the first sensing signal in time domain and/or frequency domain.

In a possible implementation, the configuration information of the first sensing signal may further include the sensing priority configuration information. The sensing priority configuration information may include a priority of a current sensing task (for example, a sensing task corresponding to the sent first sensing signal) (for example, a quality of service (QoS) priority of the sensing task) for resource preemption.

A priority of a sensing task may be determined based on one or more of the following: a requirement, corresponding to the sensing task, of an end to end (E2E) delay between communication apparatuses (for example, the first communication apparatus and the second communication apparatus) that perform sensing collaboration, a reliability/confidence requirement of the sensing task, a sensing speed precision requirement, a sensing distance precision requirement, a sensing angle resolution requirement, a sensing time resolution requirement, and the like. In an example, when the delay requirement is less than a specified delay threshold, priority sorting may be performed in a sequence of delay, reliability/confidence, speed/distance precision, and angle resolution, and a mapping relationship between a requirement of a sensing task and a sensing priority is preconfigured. When the speed/distance precision requirement is greater than a specified precision threshold and/or the delay requirement is greater than the specified delay threshold, priority sorting may be performed in a sequence of speed/distance precision, reliability/confidence, angle resolution, and delay, and a mapping relationship between a requirement of a sensing task and a sensing priority is preconfigured.

For example, the mapping relationship between a requirement of a sensing task and a sensing priority may be in a form of a table. Table 1 shows an example of the mapping relationship between a priority of a sensing task and a requirement of the sensing task provided in this embodiment of this application. A requirement of a sensing task corresponding to a priority 1 is that an E2E delay between communication apparatuses that perform sensing collaboration is not greater than 1 ms, reliability of a sensing result is not less than 99.999%, sensing distance precision is not less than 0.1 m, and sensing speed precision is not less than 10 km/h. A requirement of a sensing task corresponding to a priority 2 is that an E2E delay between communication apparatuses that perform sensing collaboration is not greater than 10 ms, reliability of a sensing result is not less than 99.999%, sensing distance precision is not less than 1 m, and sensing speed precision is not less than 20 km/h. The priority 1 is higher than the priority 2.

TABLE 1

| | | | Distance | |
|---|---|---|---|---|
| Priority | E2E delay | Reliability | precision | Speed precision |
| Priority 1 | 1 ms | 99.999% | 0.1 m | 10 km/h |
| Priority 2 | 10 ms | 99.999% | 1 m | 20 km/h |
| . . . | . . . | . . . | . . . | . . . |

The non-collaborative sensing communication apparatus of the first communication apparatus may further perform interference avoidance based on a priority of a sensing task. In an example, when a load of a resource (or a channel) carrying the first sensing signal is low, the non-collaborative sensing communication apparatus may not consider a priority of a sensing task, and perform interference avoidance in an orthogonal resource configuration based on the resource configuration information of the first sensing signal. When the load of the resource (or the channel) carrying the first sensing signal is high, the non-collaborative sensing communication apparatus may perform interference avoidance based on the resource configuration information of the first sensing signal for transmission of a service whose priority is lower than a priority of a sensing task, for example, perform service transmission by using another resource or by reducing a transmit power. The load of the resource carrying the first sensing signal may be determined depending on whether one or more of the following: a channel busy ratio (CBR), a reference signal received power (RSRP), and the like of the resource (or the channel) carrying the first sensing signal are greater than or equal to a specified threshold, for example, is high if yes, or is low if not.

In a possible implementation, priorities of a sensing service and a communication service (for example, a data communication/control service) may be further preconfigured in a communication apparatus (for example, the first communication apparatus, the second communication apparatus, or the non-collaborative communication apparatus of the first communication apparatus) or a sensing apparatus (including an apparatus having both a communication function and a sensing function). For example, a common control channel configured for communication or a channel carrying a common control message always has a higher priority than a sensing service. The common control channel may be a broadcast channel, a data channel carrying a system message, or a data channel carrying a paging message. If transmission of a service that conflicts with a resource of the first sensing signal exists, the non-collaborative sensing communication apparatus of the first communication apparatus may alternatively determine, depending on whether a priority of the conflicting service is higher than a priority of a sensing service, whether to perform interference avoidance.

It should be understood that the configuration information of the first sensing signal may alternatively include only the sensing priority configuration information of the first sensing signal. The non-collaborative sensing communication apparatus of the first communication apparatus may be configured by default to perform interference avoidance on a specific resource after the first information (for example, a specified quantity of symbols after a symbol occupied by the first information) based on the sensing priority configuration information of the first sensing signal, to avoid interference caused by data/a signal transmitted by the non-collaborative sensing communication apparatus to transmission of the first sensing signal.
S402: The second communication apparatus determines a first measurement result based on the first sensing signal.

The second communication apparatus may measure the received first sensing signal to determine the first measurement result. In an example, refer to the diagram of the distributed control network shown in FIG. 2. For example, the first communication apparatus is the active device 1, the second communication apparatus is the active device 2, and a potential sensing target is the passive device 1. After being reflected by the potential sensing target, the first sensing signal sent by the first communication apparatus may reach the second communication apparatus through a plurality of paths, and be received by the second communication apparatus. The second communication apparatus may perform a measurement based on the first sensing signal separately received on the plurality of paths, to obtain information such as time of arrival (ToA), an azimuth of arrival (AoA), a zenith of arrival (ZoA), signal strength, a beam index, or a time difference of arrival (TDoA) of the first sensing signal separately corresponding to the plurality of paths. In addition, the first measurement result may be determined based on the information obtained through the measurement. For example, the information obtained through the measurement may be used as the first measurement result. Alternatively, information such as ToA, an AoA, a ZoA, signal strength, a Doppler shift, a Doppler spread, a beam index, or a TDoA of the first sensing signal corresponding to a corresponding path is selected from a plurality of paths as the first measurement result in descending order of signal strength based on a preconfigured quantity of paths (a path quantity). Alternatively, the second communication apparatus may summarize, based on a preconfigured quantity of beams, measurement information of the first sensing signal separately received by the second communication apparatus on a plurality of beams, and use summarized measurement information as the first measurement result. The TDoA may be a time difference of arrival of sensing signals from different sending apparatuses, or a time difference of a same sensing signal received through different paths. For example, the TDoA of the first sensing signal corresponding to the path may be a time difference between time of receiving the first sensing signal by the second communication apparatus from the first communication apparatus through the path and time of receiving another sensing signal by the second communication apparatus from another communication apparatus; or may be a time difference between time of receiving the first sensing signal by the second communication apparatus from the first communication apparatus through the path and time of receiving the first sensing signal by the second communication apparatus from the first communication apparatus through another path (for example, a first path for receiving the first sensing signal).

A manner in which the second communication apparatus determines the first measurement result is not limited in this application.
S403: The second communication apparatus sends the first measurement result, and correspondingly the first communication apparatus receives the first measurement result.

The first measurement result is used for sensing.

In a possible implementation, in the distributed control network shown in FIG. 2, after the first communication apparatus (for example, the active device 1) receives the first measurement result from the second communication apparatus (for example, the active device 2), the first communication apparatus may perform sensing based on the first measurement result, for example, may determine an orientation of a sensing target (for example, the passive device 1) relative to the second communication apparatus and/or the first communication apparatus based on the AoA and the ZoA at which the first sensing signal arrives at the second communication apparatus and that are included in the measurement result.

In another possible implementation, in the centralized control network shown in FIG. 3, after the first communication apparatus (for example, the active device 1) receives the first measurement result from the second communication apparatus (for example, the active device 2), the first communication apparatus can perform sensing based on the first measurement result, the first communication apparatus can also feed back the first measurement result to a centralized control node (for example, the network device in FIG. 3), and the network device performs sensing based on the first measurement result. Optionally, the first communication apparatus may alternatively be a centralized control node.

In some implementations, to further improve sensing precision, the first communication apparatus may further measure an echo signal of the first sensing signal to determine a second measurement result, and send the second measurement result, for example, send the second measurement result through a measurement link. The second measurement result may include round trip time (RTT) or one-way time between the first communication apparatus and the potential sensing target, an AoA and a ZoA of an echo signal in a global coordinate system (or a world coordinate system), signal received strength, and the like. An azimuth of departure (AoD), a zenith of departure (ZoD), sending time, and the like of the first sensing signal are determined before sending, and the first communication apparatus may include the AoD, the ZoD, the sending time, and the like of the first sensing signal in the first information for sending.

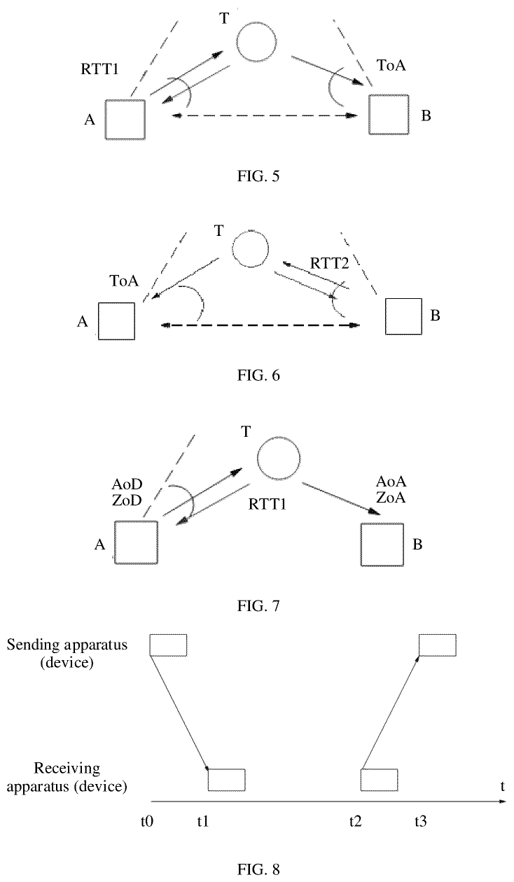

FIG. 5 is a diagram of a sensing measurement, where A represents the first communication apparatus, B represents the second communication apparatus, T represents the potential sensing target, and a unidirectional arrow represents a direction of sending or reflecting the first sensing signal. After sending the first sensing signal, the first communication apparatus may further measure a first sensing signal reflected by the potential sensing target, and send, to the second communication apparatus, the second measurement result including information such as RTT1 or one-way time between the first communication apparatus and the potential sensing target, and an AoA and a ZoA at which the echo signal of the first sensing signal arrives at the first communication apparatus. The second communication apparatus may further correct, based on the second measurement result, measurement information of the first sensing signal received by the second communication apparatus. For example, the second communication apparatus determines a location (including an orientation and a distance) of the potential sensing target relative to the first communication apparatus based on the RTT1 or the one-way time between the first communication apparatus and the potential sensing target, and the AoA, the ZoA, and the like of receiving the echo signal of the first sensing signal by the first communication apparatus, and then determines an orientation of the potential sensing target relative to the second communication apparatus based on a location of the second communication apparatus and a location of the first communication apparatus, and corrects the AoA, the ZoA, and the like of the first sensing signal that are determined by the second communication apparatus. It may be understood that the second communication apparatus may further determine a sensing result of the potential sensing target with reference to the second measurement result and the first measurement result, and feed back the sensing result (for example, the location of the potential sensing target) as the first measurement result to the first communication apparatus, to reduce signaling overheads.

In a possible implementation, the sent first information may further include configuration information of a third channel resource and/or third indication information, where the third channel resource is used for transmission of the second measurement result, and the third indication information indicates whether the first communication apparatus sends the second measurement result, so that the second communication apparatus learns whether the first communication apparatus sends the second measurement result, sends a resource for transmitting the second measurement result, and receives the second measurement result. The configuration information of the third channel resource may include a sending start time indication, a time-frequency resource used for transmission, and a QCL indication of a reference signal on the third channel resource. The sending start time indication may include sending start time, or a time offset between the sending start time and a first channel resource carrying the first information. The sending start time indication may be predefined, and is related to a subcarrier spacing. For example, different subcarrier spacings may correspond to different time. The time offset specifically corresponds to time of receiving and processing the echo signal (that is, the first sensing signal reflected by the potential sensing target) of the first sensing signal by the transmitting end of the first sensing signal (that is, the first communication apparatus). The foregoing QCL indication may indicate that there is a QCL relationship between a reference signal transmitted by using the third channel resource and the first sensing signal based on one or more large-scale parameters, or indicate that there is a QCL relationship, based on one or more large-scale parameters, between the reference signal transmitted by using the third channel resource and the reference signal of the channel carrying the first information, so that the receiving end (for example, the second communication apparatus) can reuse, based on the QCL relationship, some or all large-scale parameters of the first sensing signal or the channel carrying the first information, thereby simplifying a process of receiving and processing the second measurement result carried on the third channel resource. The large-scale parameter may include one or more of the following: an average channel gain, an average delay, a Doppler spread, a delay spread, and a receiving angle.

It should be understood that the configuration information of the third channel resource and/or the third indication information are/is not limited to being included in the first information, and may alternatively be sent by using other information, for example, by using an A^{th} piece of information. The A^{th} piece of information and the first information may be transmitted by occupying a same channel resource.

In some implementations, the second communication apparatus may also send first feedback information (or referred to as fourth information) and second sensing signal, where the first feedback information includes configuration information of the second sensing signal; and may determine and send a third measurement result based on an echo signal of the second sensing signal. A principle of determining the third measurement result by the second communication apparatus based on the echo signal of the second sensing signal is similar to a principle of determining the second measurement result by the first communication apparatus based on the echo signal of the first sensing signal, and details are not described again. The third measurement result may include round trip time RTT2 or one-way time between the second communication apparatus and the potential sensing target, an AoA and a ZoA of an echo signal in a global coordinate system (or a world coordinate system), and the like. FIG. 6 is a diagram of a sensing measurement, where A represents the first communication apparatus, B represents the second communication apparatus, T represents the potential sensing target, and a unidirectional arrow represents a direction of sending or reflecting the second sensing signal. After sending the second sensing signal, the second communication apparatus may further measure a second sensing signal reflected by the potential sensing target, and send, to the first communication apparatus, the third measurement result including information such as RTT2 or one-way time between the second communication apparatus and the potential sensing target, and an AoA and a ZoA at which the echo signal of the second sensing signal arrives at the second communication apparatus.

In addition, the first communication apparatus may also receive the first feedback information (or referred to as the fourth information) and the second sensing signal, and determine a fourth measurement result based on the second sensing signal. Both the third measurement result and the fourth measurement result may also be used for sensing.

It should be understood that sensing may be performed based on one or more of the following: the first measurement result, the second measurement result, the third measurement result, the fourth measurement result, and the like. For example, in the distributed control network shown in FIG. 2, the first communication apparatus (for example, the active device 1) may perform sensing based on one of the first measurement result, the second measurement result, the third measurement result, the fourth measurement result, and the like, for example, determine the orientation of the potential sensing target (for example, the passive device 1) relative to the first communication apparatus and/or the second communication apparatus; or may perform sensing based on a plurality of the first measurement result, the second measurement result, the third measurement result, the fourth measurement result, and the like, for example, based on the first measurement result and the second measurement result, for example, determine a location of the potential sensing target in the global coordinate system (or the world coordinate system).

Similarly, in the centralized control network shown in FIG. 3, the first communication apparatus (for example, the active device 1) may feed back one or more of the following: the first measurement result, the second measurement result, the third measurement result, the fourth measurement result, and the like to the centralized control node (for example, the network device in FIG. 3), and the network device performs sensing based on the measurement result fed back by the first communication apparatus.

In a possible implementation, a measurement method and/or a measurement requirement for measuring the first sensing signal may be determined by the second communication apparatus. For example, the second communication apparatus may preconfigure a measurement method and/or a measurement requirement for measuring a sensing signal (for example, the first sensing signal) sent by another communication apparatus. Alternatively, one measurement method and/or measurement requirement are/is selected from a plurality of preconfigured measurement methods and/or measurement requirements as the measurement method and/or the measurement requirement for measuring the first sensing signal. Certainly, the foregoing measurement method and/or measurement requirement for measuring the first sensing signal may alternatively be indicated by the first communication apparatus to the second communication apparatus.

In a possible implementation, the first communication apparatus may further send second information, where the second information may include measurement method indication information. The measurement method may include one or more of the following: self-sensed round trip time (self-RTT), transmit-receive self-sensed round trip time (TxRx-selfRTT), a transmit-receive time difference (Tx&Rx time difference), multi-round trip time (multi-RTT), time of arrival (ToA), a time difference of arrival (TDoA), an AoD, a ZoD, an AoA, a ZoA, and the like. Different measurement methods correspond to measurements of different physical quantities (or measurement quantities) and subsequent feedback transmission. Joint use of a plurality of measurement methods corresponds to obtaining of a plurality of physical quantities, which can improve sensing precision, reduce a false detection rate, and improve sensing reliability. Specifically, the foregoing measurement methods may be classified into a self-sensed RTT based measurement, an angle-based measurement, and a time-based measurement.

The self-sensed RTT based measurement may include a self-RTT measurement, that is, a communication apparatus (or an apparatus) measures a sensing signal sent by the communication apparatus (or the apparatus), to obtain a round-trip delay or round-trip time. This self-sensing measurement may be performed by a transmitting end of the second information (for example, the first communication apparatus), or may be performed by a receiving end of the second information (for example, the second communication apparatus), or may be performed by both ends. The measurement method indication information may indicate whether the receiving end of the second information (for example, the second communication apparatus) uses this method to perform a measurement, for example, whether to send the second sensing signal, and perform a measurement feedback on the echo signal of the second sensing signal.

The angle-based measurement may include a measurement of an AoD and a ZoD related to a sending angle, or an AoA and a ZoA related to a receiving angle. The sending angle may be a horizontal angle and a vertical angle corresponding to a signal/channel sent by a sending apparatus. The receiving angle corresponds to a horizontal angle and a vertical angle at which a sending apparatus receives an echo signal of a signal sent by the sending apparatus, or a horizontal angle and a vertical angle obtained by measuring a signal sent by a peer apparatus. This is particularly suitable for high-frequency beam-based transmission.

In an example, FIG. 7 is a diagram of a sensing measurement, where A represents the

first communication apparatus, B represents the second communication apparatus, T represents the potential sensing target, and a unidirectional arrow represents a direction of sending or reflecting the first sensing signal. The first communication apparatus may obtain an AoD and a ZoD for sending the first sensing signal, and the second communication apparatus may obtain an AoA and a ZoA of the first sensing signal. In this way, the AoD and the ZoD related to the sending angle and the AoA and the ZoA related to the receiving angle are measured, so that direction information of the potential perceived target T can be obtained.

The time-based measurement may include a ToA, TDoA, or multi-RTT measurement. ToA is for a time of arrival measurement. Refer to a diagram of a time-based measurement shown in FIG. 8. Time of receiving a sensing block or a sensing signal of a sending apparatus (for example, the first communication apparatus) by a receiving apparatus (for example, the second communication apparatus) is t1, and ToA is t1. A TDoA reflects a time difference of arrival, and may be a time difference for sensing blocks or sensing signals from different sending apparatuses. In a multi-RTT method, a time difference between sensing block sending and sensing block receiving is used. The receiving apparatus reports the value to the sending apparatus, and the sending apparatus may determine a value of RTT between the sending apparatus and the receiving apparatus based on time of sending a sensing block previously and time of receiving the sensing block currently. As shown in FIG. 8, t0 is time at which the sending apparatus sends a sensing signal, t1 is time at which the receiving apparatus receives the sensing signal sent by the sending apparatus, t2 is time at which the receiving apparatus sends the sensing signal, and t3 is time at which the sending apparatus receives the sensing signal sent by the receiving apparatus. In this case, multi-RTT may be equal to t1−t0+t3−t2, indicating time for the sensing signal to make one round trip between the sending apparatus and the receiving apparatus. Theoretically, the value is equal to a sum of a self-RTT value on a sending apparatus side and a self-RTT value on a receiving apparatus side. The self-RTT value on the receiving apparatus side may be obtained by further combining the value with the self-RTT value on the sending apparatus side (for example, by taking a difference), or the self-RTT value on the sending apparatus may be obtained by combining the value with the self-RTT value on the receiving apparatus side.

It should be understood that the self-sensed RTT based measurement, the angle-based measurement, and the time-based measurement may be used separately or jointly.

In a possible implementation, the second information may further include a measurement requirement (which may also be referred to as a collaborative measurement quantity and requirement), and the measurement requirement may be from a network device, or may be configured based on an application service request or the like. The measurement requirement may include one or more of the following: requirements such as precision, resolution, a detection probability, and a false detection rate corresponding to a measurement quantity (or a sensing quantity), reliability corresponding to current sensing, a maximum quantity of multipaths that needs to be fed back and a corresponding measurement quantity, a maximum quantity of beams that is fed back, whether to perform a beam index feedback, and the like. The measurement quantity may be, for example, a speed, a distance, or an angle. The reliability/detection probability is related to a quantity of times of repeatedly sending a sensing signal. For example, a higher reliability/detection probability may indicate a larger quantity of repetitions.

In a possible implementation, the second communication apparatus may further determine, based on the measurement requirement, a measurement result fed back to the first communication apparatus. For example, the first measurement result that needs to be fed back to the first communication apparatus is determined based on the measurement requirement and the first sensing signal reflected by the potential sensing target. For example, based on a plurality of times of receiving the first sensing signal reflected by the sensing target, a plurality of locations and time of the potential sensing target are determined, a speed of the potential sensing target is determined, and the speed of the potential sensing target is used as the first measurement result for a feedback.

In a possible implementation, the second communication apparatus may further determine, based on the measurement requirement, resource allocation used for collaborative sensing. For example, if a requirement such as resolution corresponding to an angle is higher, the second communication apparatus may allocate more antenna resources to receive the first sensing signal, to obtain more accurate AoA and/or ZoA information. For example, the antenna resource may include a quantity of antennas or a quantity of antenna ports.

In some implementations, the first communication apparatus may further send third information (the third information may also be referred to as collaborative sensing request information), where the third information may include a measurement feedback configuration for configuring a measurement feedback of the second communication apparatus, for example, a configuration indicating the second communication apparatus to transmit the first measurement result. The measurement feedback configuration may include one or more of the following: a time domain resource range configuration for a measurement feedback, a frequency domain resource range configuration for a measurement feedback, and a measurement feedback content configuration. The third information may further include first indication information and/or second indication information, where the first indication information indicates the second communication apparatus whether to send the second sensing signal, and the second indication information indicates the second communication apparatus whether to perform a measurement feedback on the echo signal of the second sensing signal sent by the second communication apparatus.

In a possible implementation, to ensure sensing precision, sensing collaboration may be performed by using a multi-hop communication apparatus, and sensing is performed based on a multi-hop measurement result. For example, the first communication apparatus may send the first sensing signal, and the second communication apparatus may measure the first sensing signal to determine a measurement result (a first hop); and the second communication apparatus may further send the second sensing signal, and a third communication apparatus may measure the second sensing signal to determine a measurement result (a second hop), where both the measurement results determined by the second communication apparatus and the third communication apparatus may be used for sensing. When N-hop (N is greater than or equal to 2) collaborative sensing (or an N-hop sensing signal measurement) is performed, the third information may further include one or more of the following: a measurement hop count N, an N-hop measurement delay budget, and a current hop count, for controlling N-hop collaborative sensing. The N-hop measurement delay budget (which may also be referred to as an N-hop delay requirement) affects processing time of the receiving apparatus and a measurement feedback time window. The measurement hop count N (which may also be referred to as a maximum hop count) limits a sensing measurement hop count. A communication apparatus at a sensing signal receiving end may determine, based on the measurement hop count N and the current hop count, whether a next-hop (or next-step) collaborative sensing communication apparatus needs to perform a sensing measurement feedback, whether a sensing signal needs to be sent to the next-hop communication apparatus, and the like.

The time domain resource range configuration and the frequency domain resource range configuration for a measurement feedback may also be referred to as a time domain resource range configuration and a frequency domain resource range configuration for feedback listening or feedback sending, so that larger decision space can be reserved for the sensing signal receiving end (for example, the first communication apparatus that receives the first sensing signal), and a feedback resource can be selected in a time domain resource range and a frequency domain range for a measurement feedback. Compared with a method for fixedly configuring a feedback resource, this can improve resource efficiency.

In some implementations, information related to the first communication apparatus such as the location and a device identity (ID) of the first communication apparatus, and information such as an AoD, a ZoD, and a transmit power that are sent by using the first sensing signal may also be sent by using the third information, so that a collaborative sensing communication apparatus such as the second communication apparatus determines a sensing or measurement result.

In this embodiment of this application, information such as the first information, the second information, the third information, and the second measurement result may be mapped to channel resources, and carried (or transmitted) by using the channel resources. A sensing signal or the like is mapped to a signal resource, and is carried (or transmitted) by using the signal resource. The first information may not only include the configuration information of the first sensing signal, but also include configuration information of the channel resources carrying the second information, the third information, the second measurement result, and the like. In an example, a second channel resource is used for transmission of the second information and/or the third information, that is, the second information and/or the third information are/is carried on the second channel resource; the first information may further include configuration information of the second channel resource; and the second communication apparatus may further receive the second information and/or the third information based on the configuration information of the second channel resource, to avoid blind detection. The third channel resource is used for transmission of the second measurement result; the first information may further include the configuration information of the third channel resource; and the second communication apparatus may further receive the second measurement result based on the configuration information of the third channel resource, to avoid blind detection. In addition, after receiving the information, the non-collaborative communication apparatus may also avoid the resource during resource selection, thereby avoiding interference.

In a possible implementation, a time domain location of the first channel resource carrying the first information may be earlier than a time domain location of a first signal resource carrying the first sensing signal. This configuration may enable a communication apparatus other than the first communication apparatus to obtain, before the first sensing signal, the configuration information of the first sensing signal that is carried in the first information, to perform interference avoidance, avoid blind detection, or perform another operation to receive the first sensing signal. This improves sensing performance.

In addition, a frequency domain resource length of the first channel resource carrying the first information may be less than or equal to a frequency domain resource length of the first signal resource carrying the first sensing signal. This configuration may be used to transmit the first sensing signal with a larger bandwidth. This helps improve sensing performance.

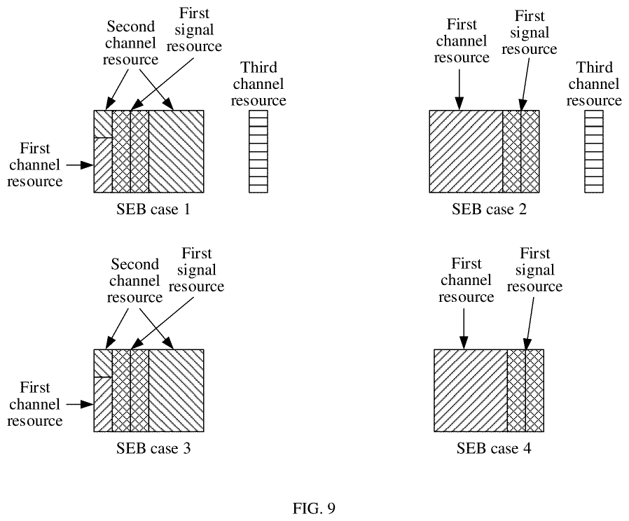

In some embodiments, the first communication apparatus may send information and a sensing signal by using a resource structure shown by a sensing resource block or a sensing block (SEB) shown in FIG. 9. It should be understood that, in this embodiment of this application, the sensing block may include a channel resource used to transmit sensing-related information (for example, the foregoing first information) and a signal resource used to transmit a sensing signal. The sensing block may be a set of a channel resource used to transmit sensing-related information and a signal resource used to transmit a sensing signal, or may be a set of sensing-related information transmitted by using a channel resource and a sensing signal transmitted by using a signal resource. The sensing block may alternatively have another name in another scenario or implementation. This is not limited in this application. A horizontal direction of the sensing block shown in FIG. 9 represents a time domain, and a vertical direction represents a frequency domain.

An SEB shown in a case1 includes the first channel resource, the second channel resource, the third channel resource, and the first signal resource. The first channel resource may carry (or be used to transmit) the first information, where the first information may include the configuration information of the first sensing signal, the configuration information of the second channel resource, and the configuration information of the third channel resource. The second channel resource may carry (or be used to transmit) the second information and/or the third information, where the second information may include information such as the measurement method and/or the measurement requirement for measuring the first sensing signal, and the third information may include information such as the measurement feedback configuration. The third channel resource may carry (or be used to transmit) the second measurement result. There is a specific time difference with transmission start time of the SEB or transmission start time of the first sensing signal, or there is a specific time difference with end time of the first channel, the second channel, or the first sensing signal. The time difference may be used by the first communication apparatus to determine the second measurement result based on the echo signal of the first sensing signal.

In the case 1, the second information and the third information are not transmitted on one channel resource as the first information, and a relatively small load of the first channel resource that carries (or is used for transmission of) the first information can be maintained. This helps another communication apparatus (for example, a communication apparatus that supports a relatively small bandwidth) perform detection and helps the another communication apparatus quickly obtain a resource configuration of the first communication apparatus for resource selection. This reduces a resource selection delay. In addition, the case 1 further includes the third channel resource that carries (or is used for transmission of) the second measurement result, so that the second communication apparatus can obtain an additional measurement result. This helps improve measurement precision and reliability.

An SEB shown in a case2 includes the first channel resource, the third channel resource, and the first signal resource. The first channel resource may carry (or be used to transmit) the first information, the second information, and the third information, where the first information may include the configuration information of the first sensing signal and the configuration information of the second channel resource, the second information may include information such as the measurement method and/or the measurement requirement for measuring the first sensing signal, and the third information may include information such as the measurement feedback configuration. The third channel resource may carry (or be used to transmit) the second measurement result. There is a specific time difference with transmission start time of the SEB or transmission start time of the first sensing signal, or there is a specific time difference with end time of the first channel or the first sensing signal. The time difference may be used by the first communication apparatus to determine the second measurement result based on the echo signal of the first sensing signal.

In the case 2, the first information, the second information, and the third information are transmitted on one channel resource, so that a code block for channel coding is relatively large, a specific coding gain is obtained, an error probability is reduced, and transmission performance is improved. In addition, the case 2 further includes the third channel resource that carries (or is used for transmission of) the second measurement result, so that the second communication apparatus can obtain an additional measurement result. This helps improve measurement precision and reliability.

An SEB shown in a case 3 includes the first channel resource, the second channel resource, and the first signal resource. The first channel resource may carry (or be used to transmit) the first information, where the first information may include the configuration information of the first sensing signal and the configuration information of the second channel resource. The second channel resource may carry (or be used to transmit) the second information and/or the third information, where the second information may include information such as the measurement method and/or the measurement requirement for measuring the first sensing signal, and the third information may include information such as the measurement feedback configuration. It may be understood that, compared with the SEB shown in the case 1, the SEB shown in the case 3 does not include the third channel resource used to transmit the second measurement result, that is, the second measurement result may not be sent. Correspondingly, the first information may not include the configuration information of the third channel resource. Alternatively, the first information may still include the configuration information of the third channel resource, but may indicate, by using indication information, the first communication apparatus not to send the second measurement result or disable transmission on the third channel resource. For example, the first information may include the third indication information indicating the first communication apparatus whether to send the second measurement result. In the SEB shown in the case 3, the third indication information indicates the first communication apparatus not to send the second measurement result.

In the case 3, the second information and the third information are not transmitted on one channel resource as the first information, and a relatively small load of the first channel resource that carries (or is used for transmission of) the first information can be maintained. This helps another communication apparatus (for example, a communication apparatus that supports a relatively small bandwidth) perform detection and helps the another communication apparatus quickly obtain a resource configuration of the first communication apparatus for resource selection. This reduces a resource selection delay.

An SEB shown in a case 4 includes the first channel resource and the first signal resource. The first channel resource may carry (or be used to transmit) the first information, the second information, and the third information, where the first information may include the configuration information of the first sensing signal, the second information may include information such as the measurement method and/or the measurement requirement for measuring the first sensing signal, and the third information may include information such as the measurement feedback configuration. Compared with the SEB shown in the case 2, the SEB shown in the case 4 does not include the third channel resource used to transmit the second measurement result, that is, the second measurement result may not be sent. Correspondingly, the first information may not include the configuration information of the third channel resource. Alternatively, the first information may still include the configuration information of the third channel resource, but may indicate, by using indication information, the first communication apparatus not to send the second measurement result or disable transmission on the third channel resource.

In the case 4, the first information, the second information, and the third information are all transmitted on one channel resource, so that a code block for channel coding is relatively large, a specific coding gain is obtained, an error probability is reduced, and transmission performance is improved.

It should be understood that the foregoing SEB is merely an example, and does not constitute a limitation on this application. For example, the first communication apparatus may alternatively send only the first information and the first sensing signal, where the SEB may include only the first channel resource carrying the first information, the first signal resource carrying the first sensing signal, and the like.

In some implementations, to simplify channel implementation, the second communication apparatus serves as a collaborative sensing apparatus of the first communication apparatus, and feedback information sent by the second communication apparatus may use an information/channel structure similar to that of the first communication apparatus. The feedback information sent by the second communication apparatus may include one or more of the following:
the first feedback information (which may also be referred to as the fourth information) and the second sensing signal. For implementation of the first feedback information, refer to the implementation of the first information. The first feedback information may include the configuration information of the second sensing signal sent by the second communication apparatus, and may further include configuration information of a channel resource carrying other feedback information, and the like. Whether the second communication apparatus sends the second sensing signal may be configured by an apparatus that initiates collaborative sensing (for example, the first communication apparatus) or another apparatus such as a network device like a base station. Alternatively, the second communication apparatus may enable a configuration based on a received measurement requirement, for example, perform enabling when the measurement requirement is greater than a specified threshold (for example, distance precision is greater than a specified distance precision threshold). When the configuration is enabled or started, a receiving apparatus (for example, the second communication apparatus) may send the first feedback information and the second sensing signal for a measurement by an apparatus that initiates collaborative sensing (for example, the first communication apparatus) or for a sensing measurement by another apparatus for multi-hop collaboration.

Second feedback information (which may also be referred to as fifth information) may correspond to the second information and/or the third information, that is, the second feedback information may include information such as a measurement method and/or a measurement requirement for measuring the second sensing signal, and a measurement feedback configuration. The second feedback information may further include information such as selection of a collaborative sensing hop count or a quantity of active collaboration nodes. In addition, the second feedback information may further include a measurement quantity feedback, for example, the first measurement result determined by the second communication apparatus.

For a measurement method, a sending apparatus (for example, the first communication apparatus) may indicate the measurement method based on a sensing requirement such as sensing precision, a sensing delay requirement, or a false detection rate (for example, by using the second information), or a receiving apparatus (for example, the second communication apparatus) may determine the measurement method based on a measurement requirement (or a sensing requirement). For example, when the first communication apparatus does not indicate a measurement method, the second communication apparatus may determine a to-be-used measurement method based on a measurement requirement sent by the first communication apparatus, to obtain a corresponding measurement quantity or measurement result. The receiving apparatus autonomously selects a measurement method, so that a delay and overheads caused by capability interaction can be avoided. When reporting a measurement result, the receiving apparatus may identify a measurement quantity of a corresponding measurement method. In a possible implementation, a measurement method set may be preconfigured, for example, configured or predefined by the network device or the sending apparatus, and each measurement method corresponds to one index. When the receiving apparatus performs reporting, the index is attached to specify a measurement method of a corresponding measurement quantity. Alternatively, corresponding measurement results may be reported in a preconfigured measurement quantity sequence. For example, reporting is performed based on a measurement method/measurement quantity sequence or index shown in Table 2.

It should be noted that the measurement method/measurement quantity sequence or index shown in Table 2 is merely an example. During actual application, a corresponding measurement result may be reported based on some or all rows in Table 2, or a measurement result may be reported in another form.

TABLE 2

| Index | Measurement method/Measurement quantity |
|---|---|
| 0 | Self-sensed RTT |
| 1 | Sending angle |
| 2 | Transmit beam number |
| 3 | Receiving angle |
| 4 | Receive beam |
| 5 | Receive beam signal strength RSRP |
| 6 | Transmit-receive time difference on a receiving |
| | apparatus side |
| 7 | Multipath number |
| 8 | Sending apparatus identifier |
| 9 | Time of arrival |
| 10 | Time difference of arrival |

The second feedback information may include one or more of the following: ToA, a TDoA, a time difference between sensing block sending and sensing block receiving, an AoA, a ZoA, sensing signal strength, a Doppler shift, and a Doppler spread, and may further carry one or more of the following: a multipath index, an index of a measured beam, an index of a measured reference signal, an identifier of an apparatus for performing a measurement (for example, the second communication apparatus), a geographical location, and the like. For further multi-hop collaborative sensing, a feedback time or time window configuration of a next hop may be further indicated. The receiving apparatus selects a resource in a feedback time window indicated by the sending apparatus. The feedback time window is equivalent to a resource selection window of the receiving apparatus, and limits a time range for resource selection. The receiving apparatus selects a feedback resource based on a candidate resource in the feedback window. Similarly, this can be extended to a multi-hop case. The receiving apparatus configures, based on a hop count and a total delay budget that are indicated by the sending apparatus, a next-hop feedback time window for hop-by-hop transfer to a last hop.

In addition, the feedback information sent by the second communication apparatus may further include information such as the third measurement result that is determined by the second communication apparatus based on the echo signal of the second sensing signal sent by the second communication apparatus.

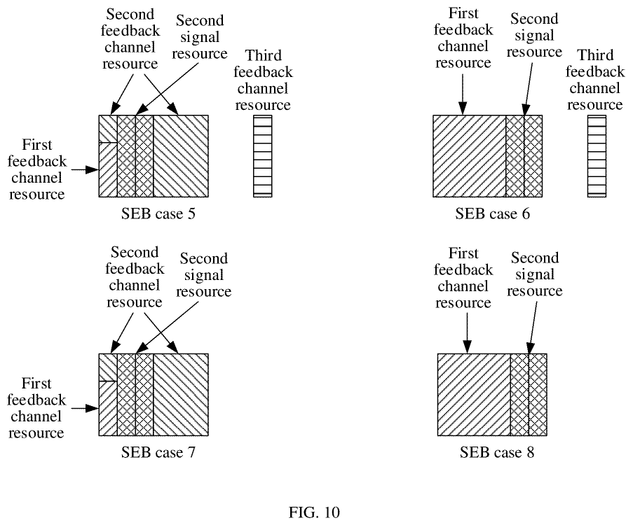

In some implementations, the second communication apparatus may send information and a sensing signal by using a resource structure shown by a sensing resource block or a sensing block shown in FIG. 10.

An SEB shown in a case 5 includes a first feedback channel resource, a second feedback channel resource, a third feedback channel resource, and a second signal resource. The first feedback channel resource may carry (or be used to transmit) the first feedback information, where the first feedback information may include the configuration information of the second sensing signal, configuration information of the second feedback channel resource, and configuration information of the third feedback channel resource. The second feedback channel resource may carry (or be used to transmit) the second feedback information, where the second feedback information may include one or more of information such as the measurement method and/or the measurement requirement for measuring the second sensing signal, the measurement feedback configuration, and the first measurement result. The third feedback channel resource may carry (or be used to transmit) the third measurement result.

In the case 5, the first feedback information and the second feedback information are not transmitted on one channel resource, and a relatively small load of the first feedback channel resource that carries (or is used for transmission of) the first feedback information can be maintained. This helps another communication apparatus (for example, a communication apparatus that supports a relatively small bandwidth) perform detection and helps another communication apparatus quickly obtain a resource configuration of the second communication apparatus for resource selection. This reduces a resource selection delay. In addition, the case 5 further includes the third feedback channel resource that carries (or is used for transmission of) the third measurement result, so that the first communication apparatus can obtain an additional measurement result. This helps improve measurement precision and reliability.

An SEB shown in a case 6 includes a first feedback channel resource, a third feedback channel resource, and a second signal resource. The first feedback channel resource may carry (or be used to transmit) the first feedback information and the second feedback information, where the first feedback information may include the configuration information of the second sensing signal and configuration information of the third feedback channel resource, and the second feedback information may include one or more of information such as the measurement method and/or the measurement requirement for measuring the second sensing signal, the measurement feedback configuration, and the first measurement result. The third feedback channel resource may carry (or be used to transmit) the third measurement result.

In the case 6, the first feedback information and the second feedback information are transmitted on one feedback channel resource, so that a code block for channel coding is relatively large, a specific coding gain is obtained, an error probability is reduced, and transmission performance is improved. In addition, the case 6 further includes the third feedback channel resource that carries (or is used for transmission of) the third measurement result, so that the first communication apparatus can obtain an additional measurement result. This helps improve measurement precision and reliability.

An SEB shown in a case 7 includes a first feedback channel resource, a second feedback channel resource, and a second signal resource. The first feedback channel resource may carry (or be used to transmit) the first feedback information, where the first feedback information may include the configuration information of the second sensing signal and configuration information of the second feedback channel resource. The second feedback channel resource may carry (or be used to transmit) the second feedback information, where the second feedback information may include one or more of information such as the measurement method and/or the measurement requirement for measuring the second sensing signal, the measurement feedback configuration the first measurement result.

In the case 7, the first feedback information and the second feedback information are not transmitted on one channel resource, and a relatively small load of the first feedback channel resource that carries (or is used for transmission of) the first feedback information can be maintained. This helps another communication apparatus (for example, a communication apparatus that supports a relatively small bandwidth) perform detection and helps the another communication apparatus quickly obtain a resource configuration of the second communication apparatus for resource selection. This reduces a resource selection delay.

An SEB shown in a case 8 includes a first feedback channel resource and a second signal resource. The first feedback channel resource may carry (or be used to transmit) the first feedback information and the second feedback information, where the first feedback information may include the configuration information of the second sensing signal and configuration information of the third feedback channel resource, and the second feedback information may include one or more of information such as the measurement method and/or the measurement requirement for measuring the second sensing signal, the measurement feedback configuration, and the first measurement result.

In the case 8, the first feedback information and the second feedback information are transmitted on one feedback channel resource, so that a code block for channel coding is relatively large, a specific coding gain is obtained, an error probability is reduced, and transmission performance is improved.

It should be understood that content included in the different information is merely an implementation. It may be understood that content included in one piece of information may be divided into a plurality of pieces of information for transmission, or content included in different information may be combined into one piece of information for transmission. For example, a part that is in the first information and that indicates the third feedback channel resource may alternatively be used as an A^{th} piece of information for separate transmission, and the second information and the third information may alternatively be combined into one piece of information for transmission.

The sensing blocks shown in the cases 5 to 8 in FIG. 10 are respectively symmetrical to the sensing blocks shown in the cases 1 to 4 in FIG. 9 in structure. This can simplify channel implementation. For beneficial effect corresponding to the sensing blocks shown in the cases 5 to 8, refer to the beneficial effect corresponding to the sensing blocks shown in the cases 1 to 4 in FIG. 9. Details are not described again.

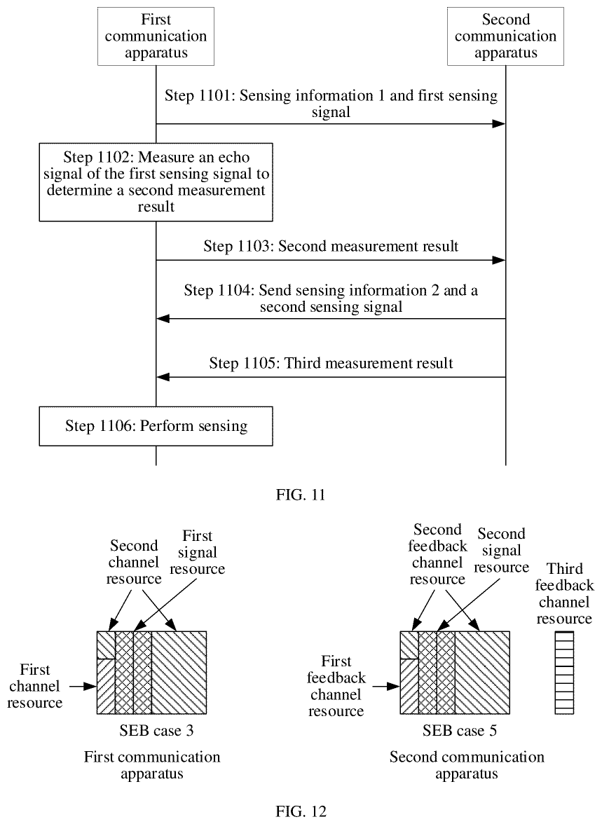

FIG. 11 is a diagram of a sensing procedure according to an embodiment of this application.

Step 1101: A first communication apparatus sends sensing information 1 and a first sensing signal, and correspondingly a second communication apparatus receives the sensing information 1 and the first sensing signal.

The sensing information 1 may include first information, and may further include second information and/or third information.

Step 1102: The first communication apparatus measures an echo signal (or a first sensing signal reflected by a potential sensing target) of the first sensing signal to determine a second measurement result.

Step 1103: The first communication apparatus sends the second measurement result, and correspondingly the second communication apparatus receives the second measurement result.

Step 1104: The second communication apparatus sends sensing information 2 and a second sensing signal, and correspondingly the first communication apparatus receives the sensing information 2 and the second sensing signal.

The sensing information 2 may include first feedback information and second feedback information, and the second feedback information may include a first measurement result determined by the second communication apparatus based on the received first sensing signal and second measurement result.

In addition, the first communication apparatus may further perform a measurement and obtain feedback information based on the sensing information 2 and the second sensing signal, for example, measure the second sensing signal to determine a fourth measurement result, and obtain the first measurement result from the sensing information 2.

Step 1105: The second communication apparatus sends a third measurement result, and correspondingly the first communication apparatus receives the third measurement result.

The third measurement result may be determined by measuring an echo signal (or a second sensing signal reflected by the potential sensing target) of the second sensing signal by the second communication apparatus.

Step 1106: The first communication apparatus performs sensing.

It may be understood that, in this embodiment of this application, the first communication apparatus may perform sensing, for example, identify an orientation of the potential sensing target based on one or more of the following: the first measurement result, the second measurement result, the third measurement result, and the fourth measurement result. Alternatively, another apparatus may perform sensing. For example, in a centralized control network, the first communication apparatus may further send one or more of the following: the first measurement result, the second measurement result, the third measurement result, and the fourth measurement result to a centralized control node (for example, a network device), and the centralized control node performs sensing. The centralized control node may be located in a radio access network, or may be located in a core network. This is not limited in this application.

In addition, for descriptions of the first information, the second information, the first measurement result, and the like, refer to the foregoing descriptions of the first information, the second information, the first measurement result, and the like. Details are not described again.

The sensing procedure shown in FIG. 11 may support a symmetric structure of sensing blocks sent and fed back by the first communication apparatus (sending apparatus) and the second communication apparatus (receiving apparatus). For example, the first communication apparatus may be supported in sending the first information, the first sensing signal, and the like by using the SEB case 1 shown in FIG. 9, and the second communication apparatus may be supported in sending the first feedback information, the second sensing signal, and the like by using the SEB case 5 shown in FIG. 10; or the first communication apparatus may be supported in sending the first information, the first sensing signal, and the like by using the SEB case 2 shown in FIG. 9, and the second communication apparatus may be supported in sending the first feedback information, the second sensing signal, and the like by using the SEB case 6 shown in FIG. 10.

In addition, when the first communication apparatus and the second communication apparatus do not send measurement results determined by measuring sensing signals sent by the first communication apparatus and the second communication apparatus, the first communication apparatus may be supported in sending the first information, the first sensing signal, and the like by using the sensing block case 3 shown in FIG. 9, and the second communication apparatus may be supported in sending the first feedback information, the second sensing signal, and the like by using the sensing block case 7 shown in FIG. 10; or the first communication apparatus is supported in sending the first information, the first sensing signal, and the like by using the sensing block case 4 shown in FIG. 9, and the second communication apparatus is supported in sending the first feedback information, the second sensing signal, and the like by using the sensing block case 8 shown in FIG. 10.

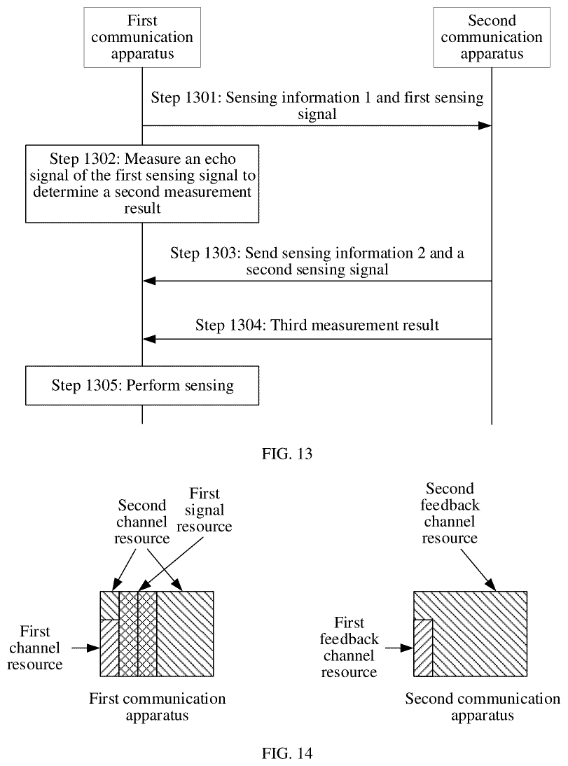

It may be understood that, in some implementations, sensing blocks sent and fed back by the first communication apparatus and the second communication apparatus may alternatively use an asymmetric structure. In an example, refer to a diagram of a structure of a sensing block sent and fed back in FIG. 12. The first communication apparatus may use the sensing block in the case 3 in FIG. 9, and the second communication apparatus may use the sensing block in the case 5 in FIG. 10. To be specific, the sensing block sent by the first communication apparatus includes a first channel resource, a second channel resource, and a first sensing signal resource, but does not include a third channel resource, that is, may not include a result of measuring an echo signal of the first sensing signal by the first communication apparatus, that is, does not include a second measurement result; and the sensing block sent by the second communication apparatus includes a first feedback channel resource, a second feedback channel resource, and a second sensing signal resource, and further includes a third feedback channel resource, that is, includes a result of measuring an echo signal of the second sensing signal by the second communication apparatus, that is, includes a third measurement result. For a corresponding sensing flowchart, refer to FIG. 13.

Step 1301: The first communication apparatus sends sensing information 1 and a first sensing signal, and correspondingly the second communication apparatus receives the sensing information 1 and the first sensing signal.

The sensing information 1 may include first information, and may further include second information and/or third information.

Step 1302: The first communication apparatus measures an echo signal (or a first sensing signal reflected by a potential sensing target) of the first sensing signal to determine a second measurement result.

Step 1303: The second communication apparatus sends sensing information 2 and a second sensing signal, and correspondingly the first communication apparatus receives the sensing information 2 and the second sensing signal.

The sensing information 2 may include first feedback information and second feedback information, and the second feedback information includes a first measurement result determined by the second communication apparatus based on the received first sensing signal.

In addition, the first communication apparatus may further perform a measurement and obtain feedback information based on the sensing information 2 and the second sensing signal, for example, measure the second sensing signal to determine a fourth measurement result, and obtain the first measurement result from the sensing information 2.

Step 1304: The second communication apparatus sends a third measurement result, and correspondingly the first communication apparatus receives the third measurement result.

The third measurement result may be determined by measuring an echo signal (or a second sensing signal reflected by the potential sensing target) of the second sensing signal by the second communication apparatus.

Step 1305: The first communication apparatus performs sensing.

It should be noted that a sequence of performing step 1302 and step 1303 is not limited in this application, that is, step 1302 may be performed before step 1303, or step 1302 and step 1303 may be performed at the same time, or step 1303 may be performed before step 1302.

Compared with the sensing procedure shown in FIG. 11, in the sensing procedure shown in FIG. 13, the first communication apparatus does not send the second measurement result, and the second communication apparatus may not consider the second measurement result when determining feedback information, for example, may directly measure the first sensing signal to obtain the first measurement result when determining the first measurement result. For a specific implementation of the sensing procedure shown in FIG. 13, refer to the implementation of the sensing procedure shown in FIG. 11. Details are not described again.

It may be understood that sensing blocks sent and fed back by the first communication apparatus and the second communication apparatus may alternatively use another asymmetric structure. In an example, refer a diagram of a structure of a sensing block sent and fed back in FIG. 14. A sensing block used by the first communication apparatus may include a first channel resource, a second channel resource, and a first sensing signal resource, and does not include a third channel resource, that is, does not include a result of measuring an echo signal of the first sensing signal by the first communication apparatus. A sensing block sent by the second communication apparatus includes a first feedback channel resource and a second feedback channel resource, but does not include a second signal resource and a third feedback signal resource, that is, does not include a second sensing signal and a result of measuring an echo signal of the second sensing signal by the second communication apparatus. A characteristic of this manner is that the second communication apparatus neither sends a sensing signal nor performs a measurement feedback on an echo signal of a sensing signal sent by the second communication apparatus, and the second communication apparatus only assists the first communication apparatus in performing a measurement feedback on the first sensing signal sent by the first communication apparatus. The first communication apparatus may enable or disable a self-sensing measurement depending on a capability and a configuration. This method has no requirement on a self-sensing measurement capability of the first communication apparatus.

In addition, it should be understood that there may alternatively be a plurality of second communication apparatuses that perform collaborative sensing with the first communication apparatus, a first sensing signal (or a sensing block) sent by the first communication apparatus may alternatively be received by the plurality of second communication apparatuses, and the first communication apparatus (or a centralized scheduling node) may alternatively perform sensing based on information fed back (for example, measurement results fed back) by the plurality of second communication apparatuses. In this case, the plurality of second communication apparatuses can provide better resource configuration flexibility based on autonomous resource selection. To be specific, when each second communication apparatus autonomously determines or accepts a configuration as a collaborative sensing apparatus, the second communication apparatus performs autonomous resource selection within a resource range (for example, time, or time and a frequency) configured by the first communication apparatus. The autonomous resource selection may use a contention-based resource selection manner, that is, a manner of performing transmission by first performing listening and then searching for an idle resource.

Different receiving apparatuses (for example, a plurality of second communication apparatuses that receive the first sensing signal) have different receiver capabilities (for example, different resolutions on time and an angle, or different antenna configurations), and may correspond to different measurement time and different interference conditions. Therefore, measurement errors may be different. Measurement is performed by one or more such receiving apparatuses, and then all measurement results are aggregated on a sensing computing device such as the first communication apparatus or a centralized control node that initiates sensing collaboration, so that sensing can also reduce a measurement error.

It may be understood that sensing blocks sent and fed back by the first communication apparatus and the second communication apparatus may alternatively use another asymmetric structure. In another example, the first communication apparatus still uses the SEB case 3 shown in FIG. 9 or FIG. 12, and the second communication apparatus may use the SEB case 6 shown in FIG. 10. A first feedback channel resource may carry (or be used to transmit) first feedback information for performing a resource configuration on a second sensing signal and configuration information of a third feedback channel resource, and the third feedback channel resource may carry (or be used to transmit) a first measurement result (a measurement result of a sensing signal sent by the first communication apparatus) and a third measurement result (a self-sensing measurement result of the second communication apparatus).

In some implementations, multi-hop collaborative sensing or an N-hop (N is greater than or equal to 2) measurement may alternatively be performed. For the multi-hop collaborative sensing or the N-hop measurement, sensing blocks sent by a source apparatus and a relay apparatus include at least a first channel and a second channel (or a first feedback channel and a second feedback channel), and a sensing signal (for example, a first sensing signal or a second sensing signal). When each apparatus serves as a receiving apparatus to perform a feedback, feedback content includes at least a measurement result for the sensing signal.

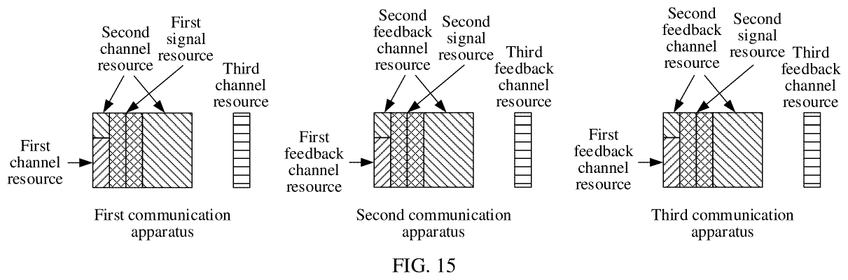

Refer to a diagram of a sensing block sent and fed back in FIG. 15. A sensing block sent by each hop apparatus includes a first channel and a second channel (or a first feedback channel and a second feedback channel), a sensing signal, and a result of measuring an echo signal of the apparatus (that is, a third channel or a third feedback channel). It should be noted that an intermediate communication apparatus and a second communication apparatus herein are used as both a receiving communication apparatus of a first communication apparatus and a sending communication apparatus of a third communication apparatus, are equivalent to relays of collaborative sensing, and also participate in a collaborative sensing measurement and feedback. Sensing information in a sensing block sent by the multi-hop relay second communication apparatus includes not only a sensing signal configuration and a feedback information report (sent to a previous-hop apparatus), but also a collaboration request such as collaboration feedback configuration information (sent to a next-hop apparatus), a measurement method, a measurement requirement, and/or the like (mainly indicated to the next-hop apparatus, and also applicable to notifying the previous-hop apparatus during autonomous decision). In other words, the sensing block includes both control information on a sending communication apparatus side and control information on a receiving communication apparatus. Generally, after a sensing signal and a channel sent by a relay communication apparatus are reflected by a potential target, a part of the signal arrives at a previous-hop apparatus, and a part of the signal arrives at a next-hop apparatus. Therefore, the channel may carry information indicated to both the previous hop and the next hop. Further, the information, as the control information on the sending and receiving communication apparatus sides, includes first information (equivalent to first feedback information), second information, third information, second feedback information (excluding a part included in the second information and the third information, which is mainly measurement feedback information), and a measurement result (a measurement result not determined based on an echo signal of a sensing signal sent by the apparatus).

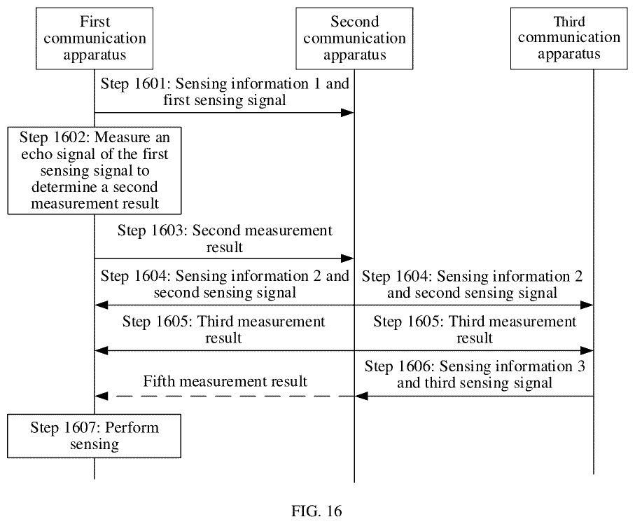

FIG. 16 is a diagram of a multi-hop sensing procedure according to an embodiment of this application.

Step 1601: A first communication apparatus sends sensing information 1 and a first sensing signal, and correspondingly a second communication apparatus receives the sensing information 1 and the first sensing signal.

The sensing information 1 may include first information, and may further include second information and/or third information.

Step 1602: The first communication apparatus measures an echo signal (or a first sensing signal reflected by a potential sensing target) of the first sensing signal to determine a second measurement result.

Step 1603: The first communication apparatus sends the second measurement result, and correspondingly the second communication apparatus receives the second measurement result.

Step 1604: The second communication apparatus sends sensing information 2 and a second sensing signal, and the first communication apparatus and a third communication apparatus receive the sensing information 2 and the second sensing signal.

The sensing information 2 may include first feedback information and second feedback information, and the second feedback information may include a first measurement result determined by the second communication apparatus based on the received first sensing signal and second measurement result. In addition, the first communication apparatus may further perform a measurement and obtain feedback information based on the sensing information 2 and the second sensing signal, for example, measure the second sensing signal to determine a fourth measurement result, and obtain the first measurement result from the sensing information 2.

Step 1605: The second communication apparatus sends a third measurement result, and correspondingly the first communication apparatus and the third communication apparatus receive the third measurement result.

The third measurement result may be determined by measuring an echo signal (or a second sensing signal reflected by the potential sensing target) of the second sensing signal by the second communication apparatus.

Step 1606: The third communication apparatus sends sensing information 3 and a third sensing signal.

Different from the one-hop sensing procedure shown in FIG. 11, in the multi-hop sensing procedure shown in FIG. 16, the third communication apparatus may also receive the sensing information 2 and the second sensing signal sent by the second communication apparatus, and the third measurement result sent by the second communication apparatus. The third communication apparatus may also determine and send the sensing information 3 and the third sensing signal based on the sensing information 2 and the second sensing signal, where the sensing information 3 may include a fifth measurement result determined by the third communication apparatus based on the received second sensing signal. For specific content included in the sensing information 3, refer to the content included in the sensing information 2. Details are not described again. In addition, the third communication apparatus may further measure an echo signal of the third sensing signal sent by the third communication apparatus, and send a measurement result (not shown in FIG. 16).

The second communication apparatus may further send information such as the fifth measurement result from the third communication apparatus to a communication apparatus that initiates sensing collaboration, for example, the first communication apparatus.

Step 1607: The first communication apparatus performs sensing.

It may be understood that, in a multi-hop collaborative sensing case, the first communication apparatus (or a centralized scheduling node) may not only perform sensing based on a measurement result fed back by a next-hop apparatus that sends sensing collaboration (for example, the second measurement result fed back by the second communication apparatus), but also perform sensing based on a measurement result (for example, the fifth measurement result) fed back by subsequent M hop apparatuses. This helps further improve sensing precision. M is greater than or equal to 1, a measurement result determined by a P^{th}-hop apparatus in M+1 hop apparatuses is determined based on a sensing signal sent by a (P−1)^{th}-hop apparatus, and P is greater than or equal to 2 and less than or equal to M. When the first communication apparatus or a centralized control unit indicates that there is a maximum hop count N, M is less than or equal to N.

In a multi-hop collaborative sensing case, capabilities of communication apparatuses that perform sensing collaboration are different (for example, one or more of the following: a bandwidth capability, a time resolution capability, and a beam angle resolution capability are different), and therefore measurement errors may be different. Multi-hop collaborative sensing may further increase measurement quantities from different apparatuses, including measurement quantities of potential targets obtained from different locations and spatial angles. This helps reduce a measurement error and improve measurement precision.

In some implementations, a sensing block sent by each hop apparatus may alternatively not include a third channel resource (or a third feedback channel resource), that is, a measurement result of an echo signal of the apparatus is not sent.

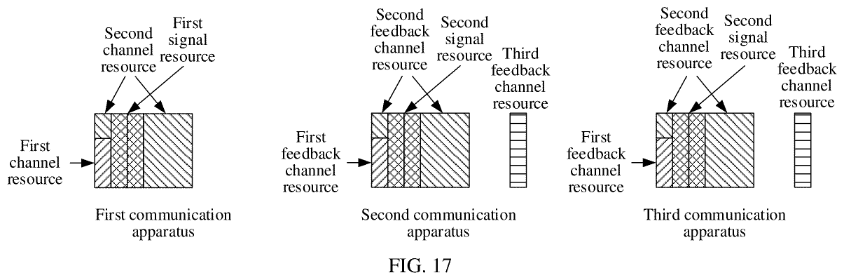

In some implementations, the sensing block sent by each hop apparatus may alternatively be symmetric. Refer to a diagram of a sensing block sent and fed back in FIG. 17. Compared with the sensing block sent by the first communication apparatus, the sensing block sent by the second communication apparatus, and the sensing block sent by the third communication apparatus in FIG. 15, in FIG. 17, the sensing block sent by the first communication apparatus may not include the third channel resource, that is, the first communication apparatus may not send a measurement result of an echo signal of the apparatus.

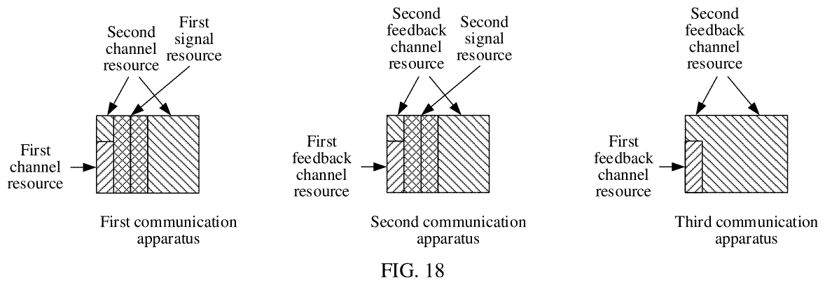

Refer to a diagram of a sensing block sent and fed back in FIG. 18. Compared with the sensing block sent by the first communication apparatus, the sensing block sent by the second communication apparatus, and the sensing block sent by the third communication apparatus in FIG. 15, in FIG. 18, the sensing block sent by the first communication apparatus, the sensing block sent by the second communication apparatus, and the sensing block sent by the third communication apparatus each may not include the third channel resource (or the third feedback channel resource), that is, each of the first communication apparatus to the third communication apparatus may not send a measurement result of an echo signal of the apparatus. In addition, a sensing block sent by a last-hop apparatus for collaborative sensing, that is, the third communication apparatus, may further not include a signal resource, and does not send a sensing signal.

In some implementations, the second communication apparatus serving as a relay may separately send the sensing block to the first communication apparatus and the third communication apparatus. Optionally, separate sending may be sending in a time division multiplexing manner. Correspondingly, the sensing blocks from the first communication apparatus and the third communication apparatus may be received in a time division multiplexing manner.

In some implementations, the centralized control node or the like may further perform, by using physical layer or higher layer control information, an indication of measuring and reporting a dedicated sensing mode for the first communication apparatus or the like. For example, for posture identification, regularity or periodicity of different physical quantities may be used to determine a posture, including a distance/delay, an angle, a location track, signal strength, Doppler, a speed, and the like. Therefore, one or more parameter ranges may be preconfigured or predefined, and a task/event is determined based on regularity of a measurement quantity in the parameter range.

In a possible implementation, the task/event may be determined depending on whether values of measurement quantities obtained at different time are within a parameter range of a parameter associated with the time. The parameter associated with the time may be a subset of a parameter set {distance, signal strength, angle, speed (or Doppler)}. For example, the time is associated with the distance, or the time is associated with the distance and the signal strength. Parameter values change regularly, for example, gradually increasing, gradually increasing and then decreasing, or periodically changing. A combination of parameters corresponds to a parameter subset, and can be used for completion of a specific task or identification of a specific target property (or event) when being grouped.

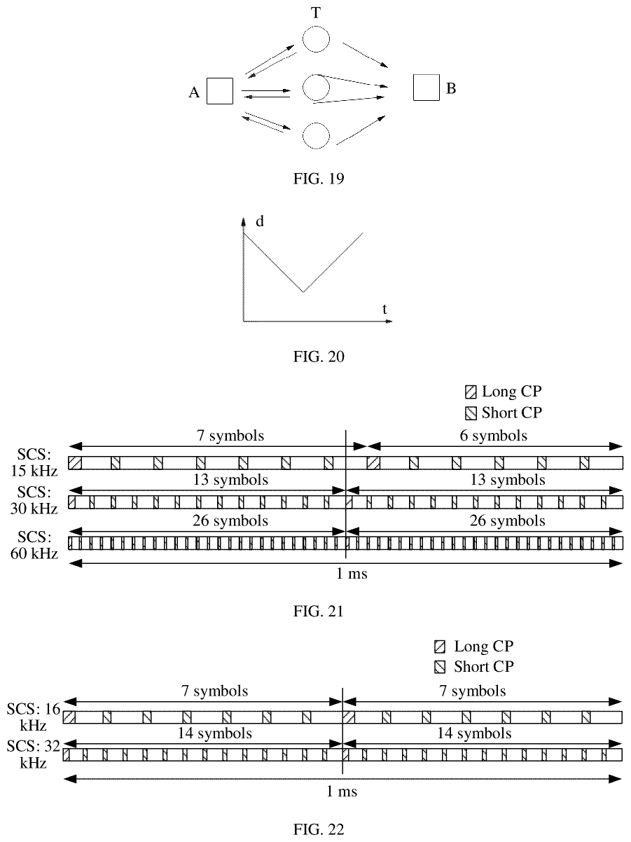

FIG. 19 is a diagram of measuring a sensing signal of an object falling. Herein, A represents a first communication apparatus, and B represents a second communication apparatus. When a potential sensing target T falls from a specific height, a first sensing signal periodically sent by the first communication apparatus is reflected by the potential sensing target T to the second communication apparatus, and an echo signal of the sensing signal sent by the first communication apparatus arrives at the first communication apparatus. The first communication apparatus may measure the echo signal to obtain an angle of arrival and round trip time, and further obtain a change status of different angles and different distances corresponding to the first communication apparatus and the potential sensing target T at different time, that is, may determine a location change status of the potential sensing target T. The second communication apparatus listens to and measures the sensing signal sent by the first communication apparatus, to be specific, receives sensing signals sent by the first communication apparatus in different angle directions at different time points. The second communication apparatus may feed back measurement information including signal strength of the measured sensing signal, an angle of receiving the sensing signal, and corresponding time of receiving the sensing signal to the first communication apparatus, where the feedback may be one feedback for a plurality of measurements, or may be measurement feedbacks one by one. The first communication apparatus may determine a movement track of the potential perceived target T based on an echo signal measurement and a feedback measurement of the second communication apparatus, and may perform posture identification. FIG. 20 is a diagram of a distance change of the potential sensing target T that is determined by the first communication apparatus based on a signal measurement shown in FIG. 19 with time. In FIG. 20, t represents time, and d represents a distance.

A control information indication and a measurement feedback bearer channel described in the foregoing parameters depend on delay sensitivity. For example, a machine such as a factory has a low-delay identification requirement for fast rotation, and a dynamic indication and a feedback are required, so as to quickly determine whether a current operation is normal, for example, whether a track is normal. There is also a delay-insensitive count such as a periodic movement count like sit-ups or bow-ups. In this case, both a measurement indication and a measurement feedback may be carried by using higher layer signaling.

In a possible implementation, a parameter range configured for posture identification may be shown in Table 3. Different time points may be associated with different parameter ranges. Parameters associated with time in Table 3 include a distance/delay, signal strength, an angle, and a speed/Doppler. A parameter range associated with a time point T0 includes: a distance/delay range D0±a0, a signal strength range S0±b0, an angle range A0±c0, and a speed/Doppler V0d0. A parameter range associated with a time point T1 includes: a distance/delay range D1±a1, a signal strength range S1±b1, an angle range A1±c1, a speed/Doppler V1±d1. A parameter range associated with a time point T2 includes: a distance/delay range D2±a2, a signal strength range S2±b2, an angle range A2±c2, a speed/Doppler V2±d2. A parameter range associated with a time point T3 includes: a distance/delay range D3±a3, a signal strength range S3±b3, an angle range A3±c3, a speed/Doppler V3±d3.

TABLE 3

| Time | Distance/Delay | Signal strength | Angle | Speed/Doppler |
|---|---|---|---|---|
| T0 | D0 ± a0 | S0 ± b0 | A0 ± c0 | V0 ± d0 |
| T1 | D1 ± a1 | S1 ± b1 | A1 ± c1 | V1 ± d1 |
| T2 | D2 ± a2 | S2 ± b2 | A2 ± c2 | V2 ± d2 |
| T3 | D3 ± a3 | S3 ± b3 | A3 ± c3 | V3 ± d3 |

For measurement reporting, a measurement result may be reported in terms of time, or whether a measurement quantity is within a parameter range may be confirmed in terms of time, where an acknowledgment (ACK) is fed back if yes, or a negative acknowledgment (NACK) is fed back if not. This case is more suitable for measurement reporting of a delay-sensitive requirement, or may be directly reporting a final posture identification result based on a predefinition.

In another case, the first communication apparatus sends parameter ranges of a plurality of time points by using sensing information (for example, third information), and the second communication apparatus detects a sensing signal sent by the first communication apparatus at each time point, and then feeds back whether the sensing signal is within a corresponding parameter range, for example, within the range if an ACK is fed back, or is not within the range if a NACK is fed back. Optionally, the second communication apparatus may alternatively report a value of a measurement quantity of each time point to the first communication apparatus.

In still another case, a sensing center or a centralized scheduling/control device (for example, a network device) configures, for the first communication apparatus, parameter ranges of a plurality of time points for determining whether a task succeeds or fails, and then the first communication apparatus determines, by using the first communication apparatus or by cooperating with another collaboration apparatus (for example, the second communication apparatus), a parameter value corresponding to a parameter of each time point, to determine whether the parameter value of each time point is within a configured parameter range, and reports information about task success or failure to the centralized scheduling/control device. The first communication apparatus may report the information about the task success or failure to the centralized scheduling/control device in one or more of the following manners:

Manner 1: Directly report the task success or failure, for example, report 1-bit indication information to indicate that the task succeeds or fails. In an example, if parameter values of all time points that are determined by the first communication apparatus all are within corresponding parameter ranges of the time points, the 1-bit indication information may be configured as 1, to indicate that the task succeeds; or if a parameter value of a specific time point is not within a parameter range of the time point in parameter values of all time points that are determined by the first communication apparatus, the 1-bit indication information may be configured as 0, to indicate that the task fails. This reporting manner can reduce signaling overheads.

It may be understood that, in the reporting manner 1, the first communication apparatus may alternatively report the information about the task success or failure only when the task succeeds or fails. For example, the first communication apparatus reports the task failure only when the task fails. If the first communication apparatus does not report the task failure, the centralized scheduling/control device may consider that the task succeeds by default.

Manner 2: Report a parameter value of each time point that is not within a parameter range of the time point. This reporting manner helps the centralized scheduling/control device learn of an abnormal parameter value, and may provide data support for exception analysis.

Manner 3: Report a parameter value of each time point. This reporting manner helps the centralized scheduling/control device learn of the parameter value of each time point, and may be used by the centralized scheduling/control device to determine whether the task succeeds or fails.

In a communication scenario such as 5G, a CP may be used to resist multipath interference. A longer CP length in an orthogonal frequency division multiplexing symbol (referred to as a symbol below) indicates better multipath interference resistance effect. During sensing, a sensing signal (for example, the first sensing signal) may experience one or more reflections including a reflection by a transmitting end before reaching a destination end, causing a larger multipath delay. For example, in a case, a sensing signal is reflected by a potential sensing target to a receiving end after being reflected in a round-trip manner between the transmitting end and the potential sensing target. Compared with a case in which a sensing signal is directly reflected by the potential sensing target to the receiving end, this may make a maximum path length of the sensing signal be twice a minimum path length, and causes a larger multipath delay. Currently, in a communication system such as 5G, a relatively large subcarrier spacing (SCS) is configured due to a low-delay requirement, and a larger SCS usually indicates a shorter symbol length, causing a shorter CP length in a symbol. Therefore, when a sensing signal is sent in the communication system such as 5G, to cope with multipath interference, a requirement for a long CP is further increased. Currently, the communication system such as 5G supports a multiple relationship between CP lengths of different SCSs. In an SCS-optimized system, if a CP length is switched to another SCS, system performance may be adversely affected. For example, if the CP length is switched from a 120 kilohertz (kHz) SCS to 60 kHz, although the CP length is increased, a higher requirement is imposed on a fast Fourier transform (FFT) size in a same bandwidth, a frequency offset and phase noise may be more sensitive, this is not conducive to supporting a low delay, and the like. Therefore, in this embodiment of this application, an extended CP may be considered to be introduced during sensing. An extended CP configuration herein may be preconfigured, or may be indicated to a sensing signal receiving apparatus by using an information configuration sent by a sensing signal sending apparatus. For example, for the first sensing signal, the first communication apparatus may include a CP configuration of the first sensing signal in the sent first information (or the resource configuration information of the first sensing signal that is included in the first information), to indicate the CP configuration of the first sensing signal to the second communication apparatus receiving the first sensing signal. Correspondingly, in a possible application, an extended CP is configured for an ultra-reliable and low latency communications (URLLC) service, and a normal CP is configured for an enhanced mobile broadband (eMBB) service.

In a possible implementation, a CP extension manner is that a CP time ratio in unit time is 2/16 or 2/15. An SCS spacing is (15+m)*2\hat{ }n kHz, where m=0 or 1, and n is an integer greater than or equal to 0.

Example 1: A subcarrier spacing of a sensing signal (for example, the first sensing signal) is 15*2\hat{ }n kHz, and a CP time ratio corresponding to the sensing signal is 2/15.

Example 1 has a same subcarrier spacing configuration as but a different CP length from a 5G OFDM system. A quantity of available symbols in unit time is reduced as CP time. A CP length twice that in the 5G communication system is supported, which can support sensing signal reflection receiving, so that a multipath signal remains within a CP range. It is considered that the CP time ratio in the unit time is doubled to 2/15 instead of current 1/15, so that the CP length is doubled. Therefore, some or all subcarrier spacings corresponding to the extended CP are the same as those in an existing system, namely, 15*2\hat{ }n kHz, where n=0, 1, 2, . . . , N, N is an integer, and N is a parameter that is predefined or configured by a system and that corresponds to a maximum subcarrier spacing. This extended CP may reuse a subcarrier spacing of 5G. An advantage is that this can be used in a same scenario, a slot and a frame structure that are compatible with the existing OFDM system are supported, and this example can be supported by flexibly configuring a quantity of symbols.

Table 4 shows total CP lengths corresponding to different subcarrier spacings in a current 5G system, quantities (namely, lengths) of sampling points corresponding to a long CP and a short CP, an available symbol length, a quantity of symbols included in a 1 millisecond (ms), and whether quantities of symbols corresponding to different SCSs in 1 ms meet a 2\hat{ }n extension, where Y indicates that the quantities meet the 2\hat{ }n extension. In Table 4, a subcarrier spacing with NR is a configuration of the current 5G system, and a subcarrier spacing with enhancement is an extended CP in the solution of this application. The available symbol length indicates a length of a symbol to which no CP is added. A quantity of 1 ms corresponds to a quantity of symbols (namely, OFDM symbols) included in 1 ms. The 2\hat{ }n extension indicates whether an extended CP also supports a corresponding extension when a subcarrier spacing is 2\hat{ }n times. It can be seen from Table 4 that a CP length corresponding to an extended CP (with an enhanced CP corresponding to a carrier) is slightly greater than 2 times a CP length in the existing OFDM system, so that a CP extension requirement can be met.

TABLE 4

| | Total CP (ms) −> Quantities | | | |
|---|---|---|---|---|
| Subcarrier | of sampling points of a long | Available | Quantity of 1 | 2\hat{ }n |
| spacing (kHz) | CP and a short CP | symbol length | ms symbols | extension |
| 15 NR | (1/15)−>144k + 16k, 144k | 1/15 | 14 | Y |
| 15 enhanced | (2/15)−>304k′ + 72k′, 304k′ | 1/15 | 13 | Y |
| 30 NR | (2/30)−>144k/2 + 16k, 144k/2 | 1/30 | 28 | Y |
| 30 enhanced | (4/30)−>304k′/2 + 72k′, | 1/30 | 26 | Y |
| | 304k′/2 | | | |
| 60 NR | (4/60)−>144k/2\hat{ }2 + 16k, | 1/60 | 56 | Y |
| | 144k/2\hat{ }2 | | | |
| 60 enhanced | (8/60)−>304k′/2\hat{ }2 + 72k′, | 1/60 | 52 | Y |
| | 304k′/2\hat{ }2 | | | |
| 120 NR | (8/120)−>144k/2\hat{ }3 + 16k, | 1/120 | 112 | Y |
| | 144k/2\hat{ }3 | | | |
| 120 enhanced | (16/120)−>304k′/2\hat{ }3 + 72k′, | 1/120 | 112 | Y |
| | 304k′/2\hat{ }3 | | | |
| . . . | . . . | . . . | . . . | Y |

Extended CP lengths corresponding to different subcarrier spacings may be summarized as a quantity of sampling points included in the following formula, where μ is 0, 1, 2, . . . , namely, coefficients corresponding to the different subcarrier spacings. If a subcarrier spacing is 15 kHz, μ=0; if a subcarrier spacing is 30 kHz, μ=1; if a subcarrier spacing is 60 kHz, μ=2; if a subcarrier spacing is 120 kHz, μ=3; and so on. In the following formula, an upper part of the formula (including a +72K part) may be used to determine a quantity of sampling points of a long CP, and a lower part of the formula (excluding the +72K part) may be used to determine a quantity of sampling points of a short CP. A difference between the quantities of sampling points of the long CP and the short CP is 72k, a normal cyclic prefix indicates a CP, and l indicates a symbol location of a CP in a slot or a time granularity. One slot or time granularity may include 7 symbols. It can be learned from the following formula that a first symbol, that is, a symbol 0, is a long CP, and the other 6 symbols are short CPs. By analogy, a seventh CP is a long CP, and the next six CPs are short CPs. A value of k is predefined. For example, a value of k in 5G is Ts/Tc=64, where Ts is a reciprocal of a product of a reference subcarrier spacing and a quantity of reference FFT points, and Tc is a reciprocal of a product of a maximum subcarrier spacing and a maximum quantity of FFT points.

$${N}_{CP , l}^{μ} = \{ \begin{matrix}304 k \cdot {2}^{- μ} + 72 k , normal cyclic prefix , l = 0 or l = 7 or l = 13 \cdot {2}^{μ} \\ 304 k \cdot {2}^{- μ} , normal cyclic prefix , l \neq 0 , l \neq 7 , and l \neq 13 \cdot {2}^{μ}\end{matrix}$$

When the extended CP is used in this application, it can be learned from a diagram of boundaries of symbols of different subcarrier spacings shown in FIG. 21 that, when a subcarrier spacing is 15 kHz, symbols cannot be aligned by using 0.5 ms as a boundary, but a boundary with a multiple of 13 symbols starting from a subcarrier spacing of 30 kHz can be aligned. In other words, different subcarrier spacings greater than 15 kHz can coexist through time division multiplexing based on a boundary of 0.5 ms. To be specific, subcarrier spacings greater than 15 kHz are aligned in time domain based on a multiple of 13 OFDM symbols, and a subcarrier spacing greater than 30 kHz can coexist with an existing subcarrier spacing in the current OFDM system in time domain at a granularity of 0.5 ms.

Based on the foregoing content, for Example 1, the subcarrier spacing of the sensing signal (for example, the first sensing signal) may be 15*2\hat{ }n kHz, the CP time ratio corresponding to the sensing signal is 2/15, the quantity of sampling points of the short CP of the extended CP is a divisor of 304, and the quantity of sampling points of the long CP is a divisor of 304+72. When SCS≥30 kHz, time units (such as slots) of different SCSs whose symbol quantities are multiples of 13 are aligned with each other.

Example 2: A subcarrier spacing of a sensing signal (for example, the first sensing signal) is (15+1)*2\hat{ }n kHz, and a CP time ratio corresponding to the sensing signal is 2/16.

Example 2 considers a case of a subcarrier spacing closest to an OFDM system and an increasing quantity of symbols, so that a quantity of extra symbols may be used to extend a CP.

In Example 2, it is considered that the CP time ratio in unit time is increased to 2/16 instead of current 1/15, so that the CP length is doubled approximately. Therefore, some or all subcarrier spacings corresponding to the extended CP are different from those in the OFDM system, namely, 16*2\hat{ }n kHz, where n=0, 1, 2, . . . , N, and N is a parameter that is predefined or configured by a system and that corresponds to a maximum subcarrier spacing. The subcarrier spacing of the extended CP is close to a subcarrier spacing of 5G. An advantage is that this can be used in a similar scenario, and a slot and a frame structure that are compatible with the existing OFDM system are supported.

Table 5 shows different subcarrier spacings in current 5G and a total CP length corresponding to an extended (or enhanced) subcarrier spacing in this application, quantities (namely, lengths) of sampling points corresponding to a long CP and a short CP, an available symbol length, a quantity of symbols included in 1 ms, and whether quantities of symbols corresponding to different SCSs in 1 ms meet a 2\hat{ }n extension. In Table 5, a subcarrier spacing with NR is a configuration of the current 5G system, and a subcarrier spacing with enhancement is the solution of this application. The available symbol length indicates a length of a symbol to which no CP is added. A quantity of 1 ms symbols corresponds to a quantity of symbols (namely, OFDM symbols) included in 1 ms. The 2\hat{ }n extension indicates whether an extended CP also supports a corresponding extension when a subcarrier spacing is 2\hat{ }n times. A value of the 2\hat{ }n extension corresponding to the subcarrier spacing in Table 5 is Y, indicating that the extended CP also supports a corresponding extension when the subcarrier spacing is 2\hat{ }n times. It can be seen from Table 5 that a CP length corresponding to an extended CP is slightly greater than 2 times a CP length in the existing OFDM system, so that a CP extension requirement can be met.

TABLE 5

| | Total CP (ms) −> Quantities | | | |
|---|---|---|---|---|
| Subcarrier spacing | of sampling points of a long | Available | Quantity of 1 | 2\hat{ }n |
| (kHz) | CP and a short CP | symbol length | ms symbols | extension |
| 15 NR | (1/15)−>144k + 16k, 144k | 1/15 | 14 | Y |
| 16 enhanced | (2/16)−>288k′ + 32k′, 288k′ | 1/16 | 14 | Y |
| 30 NR | (2/30)−>144k/2 + 16k, 144k/2 | 1/30 | 28 | Y |
| 32 enhanced | (4/32)−>288k′/2 + 32k′, | 1/32 | 28 | Y |
| | 288k′/2 | | | |
| 60 NR | (4/60)−>144k/2\hat{ }2 + 16k, | 1/60 | 56 | Y |
| | 144k/2\hat{ }2 | | | |
| 64 enhanced | (8/64)−>288k′/2\hat{ }2 + 32k′, | 1/64 | 56 | Y |
| | 288k′/2\hat{ }2 | | | |
| 120 NR | (8/120)−>144k/2\hat{ }3 + 16k, | 1/120 | 112 | Y |
| | 144k/2\hat{ }3 | | | |
| 128 enhanced | (16/128)−>288k′/2\hat{ }3 + 32k′, | 1/128 | 112 | Y |
| | 288k′/2\hat{ }3 | | | |
| . . . | . . . | . . . | . . . | Y |

Extended CP lengths corresponding to different subcarrier spacings may be summarized as a quantity of sampling points included in the following formula, where μ is 0, 1, 2, . . . , namely, coefficients corresponding to the different subcarrier spacings. In the following formula, an upper part of the formula (including a +32K part) may be used to determine a quantity of sampling points of a long CP, and a lower part of the formula (excluding the +32K part) may be used to determine a quantity of sampling points of a short CP. A difference between the quantities of sampling points of the long CP and the short CP is 32k, a normal cyclic prefix indicates a CP, and l indicates a symbol location of a CP in a slot or a time granularity. One slot or time granularity includes 7 symbols. It can be learned from the following formula that a first symbol, that is, a symbol 0, is a long CP, and the other 6 symbols are short CPs. By analogy, a seventh CP is a long CP, and the next six CPs are short CPs. A value of k is predefined. In addition, it can be seen from Table 5 that a quantity of sampling points of a similar subcarrier spacing is twice that of the existing OFDM system. The long CP appears in symbols 0, 7, 14, . . . , 7*2\hat{ }μ.

$${N}_{CP , l}^{μ} = \{ \begin{matrix}288 k \cdot {2}^{- μ} + 32 k , normal cyclic prefix , l = 0 or l = 7 \cdot {2}^{μ} \\ 288 k \cdot {2}^{- μ} , normal cyclic prefix , l \neq 0 and l \neq 7 \cdot {2}^{μ}\end{matrix}$$

When the extended CP is used in this application, it can be learned from a diagram of boundaries of symbols of different subcarrier spacings shown in FIG. 22 that, starting from a subcarrier spacing of 16 kHz, time division multiplexing coexistence of different subcarrier spacings that are multiples of 16 kHz is supported based on a boundary of 0.5 ms. To be specific, different SCSs can be aligned based on a multiple of 7 symbols, and can coexist with an existing subcarrier spacing in the current OFDM system in time domain at a granularity of 0.5 ms.

Based on the foregoing content, for Example 2, the subcarrier spacing of the sensing signal (for example, the first sensing signal) is (15+1)*2\hat{ }n kHz, the CP time ratio corresponding to the sensing signal is 2/16, the short CP of the extended CP is a divisor of 288, the long CP is a divisor of 288+32, and time units (such as slots) of different SCSs whose symbol quantities are multiples of 7 are aligned with each other.

In embodiments of this application, a transmission resource configuration used by a sensing block (or a sensing signal or the like) may depend on two resource selection manners. One manner is that a centralized scheduling node performs a configuration, where the centralized scheduling node may be a network device. The other manner is an autonomous resource selection mode of a communication apparatus (referred to as a sending apparatus below) that sends a sensing block (or a sensing signal or the like). In the first manner, the network device configures a transmission resource for the sending apparatus, and the sending apparatus sends a sensing block (or a sensing signal or the like) based on the transmission resource configured by the network device. In the second manner, the sending apparatus performs autonomous resource selection.

The following describes how to configure monitoring duration of a beam in the second resource selection manner.

For autonomous resource selection of a sending apparatus in a distributed network, the sending apparatus or a receiving apparatus may first perform monitoring or listening in a preconfigured time window, find an idle resource as a selected candidate resource (the candidate resource may also be referred to as a resource selection window), and then select a resource in the candidate resource to transmit a sensing-related signal (for example, a sensing signal) and information.

For a multi-beam transmission system, beams need to be used to perform detection or information transmission in different directions. For a manner of configuring monitoring duration in different beam directions, a specific configuration of each beam direction is considered in this application. A motivation for a specific configuration of each beam instead of a completely same configuration of each beam is as follows: (1) Based on different reliability requirements of all beam directions, for example, for a higher reliability requirement of a main driving direction, an interference measurement needs to be more accurate to avoid collision, and for a lower backward requirement, forward monitoring duration is greater than backward monitoring duration. (2) Monitoring duration is configured based on a monitoring resource tendency of a collaborative communication apparatus, and the collaborative communication apparatus reserves or pre-configures monitoring duration in a beam direction of more monitoring resources to be greater than that in another direction. (3) Based on a load in a beam, if a load in a beam direction is relatively high, for example, resource usage in the beam direction is relatively high, monitoring duration needs to be prolonged; and monitoring duration may be shortened in a beam direction with a relatively low load. (4) Monitoring duration is set beam by beam, where the monitoring duration of the beam and a sensing requirement are related to whether there is a historical monitoring result within valid time. If there are historical monitoring results in some directions, for example, historical monitoring results between current time tn and tn−t1 may be reused, service resource usage in some periods may be obtained at least based on the historical monitoring results in this period of time. In a case in which a total delay budget is limited, more monitoring time may be configured for a beam without historical data. (5) Compared with an omnidirectional equal monitoring duration configuration, the monitoring duration can be reduced based on a proportion of a quantity of beams.

In other words, in embodiments of this application, different monitoring duration (or monitoring window lengths) may be selected in different beam directions. The autonomous resource selection mode may be selected by the sending apparatus, and may be configured by a centralized scheduling node for a centralized scheduling network. Monitoring duration (pᵢ) can be independently configured for different beams that carry sensing signals; and a monitoring duration priority related to a specific beam can be configured, that is, pi corresponding to a high-priority beam is longer than pᵢ corresponding to a low-priority beam. The priority may be determined based on a beam load or a quantity of idle (or available) beam resources. A higher load or a smaller quantity of idle beam resources indicates a higher priority. In a total delay budget (for example, a packet delay budget (PDB)), for a beam for which short monitoring duration can be configured, a remaining delay budget may be used for another beam configuration for which long monitoring duration is required, and a configuration of non-uniform monitoring duration between beams is supported. p₁+p₂+ . . . pₙ≤PDB−pᵣ (resource selection window length), where p₁, p₂, . . . , and pₙ represent monitoring duration of time windows 1, 2, . . . , and n respectively. With assistance of the centralized scheduling node, a monitoring duration set may be configured for the sending apparatus by using higher layer signaling such as RRC signaling, and dynamic control information indicates to dynamically indicate/activate the monitoring duration set.

Table 6 shows an example in which the sending apparatus autonomously selects corresponding monitoring duration on four beams, where x indicates that a beam in a column in which x is located corresponds to monitoring duration in a row in which x is located. Monitoring duration on a beam 1 is 0 ms, that is, no sensing signal is sent; monitoring duration on a beam 2 is 0.5 ms; monitoring duration on a beam 3 is 100 ms; and monitoring duration on a beam 4 is 100 ms. In a possible implementation, the sending apparatus may further send, to the receiving apparatus, monitoring duration on a specific beam currently carrying a sensing signal. For example, when sending first information and a first sensing signal, a first communication apparatus may further include, in the first information, monitoring duration on a beam carrying the first sensing signal, so that a communication apparatus that receives the first information and the first sensing signal performs monitoring (or receiving) on the beam of the first sensing signal based on the monitoring duration.

TABLE 6

| Monitoring duration/Beam | Beam 1 | Beam 2 | Beam 3 | Beam 4 |
|---|---|---|---|---|
| Monitoring duration 1: 0 | x | | | |
| Monitoring duration 2: 0.5 ms | | x | | |
| Monitoring duration 3: 1 ms | | | | |
| Monitoring duration 4: 10 ms | | | | |
| Monitoring duration 5: 100 ms | | | x | x |

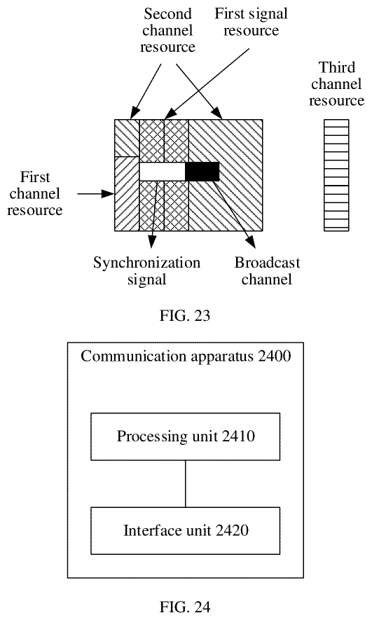

In addition, it should be understood that, in embodiments of this application, when transmission of a sensing block (or information or a signal carried in the sensing block) overlaps transmission of a synchronization block (or information or a signal carried in the synchronization block), as shown in a diagram of overlapping between a sensing block and a synchronization block in FIG. 23, a synchronization signal sequence may be a part of a sensing signal sequence (for example, a first sensing signal sequence), and a broadcast channel or a synchronization signal indicates that a current mode is a mode of overlapping between the synchronization block and the sensing block, or may indicate that the synchronization signal is a part of the sensing signal. The indication information may be indicated by a broadcast channel load or a synchronization signal sequence such as a scrambling ID or a cyclic shift value. When the sensing signal overlaps the synchronization signal, the sensing signal sequence may be in a segment sequence mode, that is, a part of the sensing signal sequence is the synchronization signal sequence. Optionally, the sensing signal may be a repetition of the synchronization signal. A sensing signal beam is the same as a synchronization signal beam. There is a QCL relationship about a large-scale parameter delay spread, a Doppler shift, an average channel gain, an average delay, and a spatial parameter between the sensing signal and the synchronization signal. Rate matching is performed on transmission of a broadcast channel by a channel (such as a first channel or a second channel) carrying sensing information, that is, a resource occupied by the broadcast channel is kept, and a resource occupied by the channel carrying the sensing information is compressed, so that the resources do not conflict. The resource occupied by the channel carrying the sensing information is indicated by the first channel (that is, information carried by the first channel).

It may be understood that, to implement functions in the foregoing embodiments, the first communication apparatus and the second communication apparatus include corresponding hardware structures and/or software modules for performing the functions. A person skilled in the art should be easily aware that, in combination with units and method steps of the examples described in embodiments disclosed in this application, this application may be implemented by using hardware or a combination of hardware and computer software. Whether a function is performed by hardware or hardware driven by computer software depends on particular application scenarios and design constraints of the technical solutions.

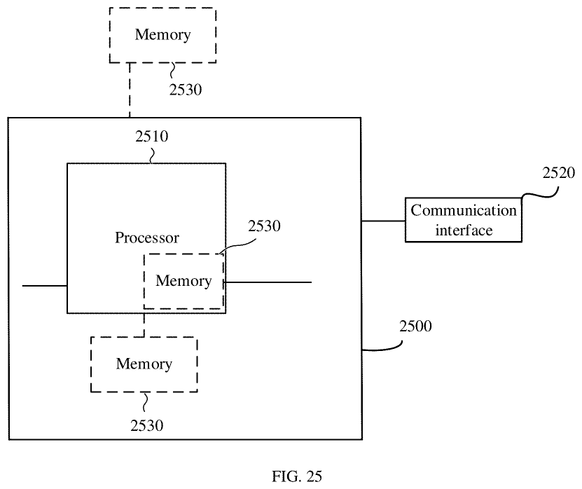

FIG. 24 and FIG. 25 are diagrams of structures of possible communication apparatuses according to embodiments of this application. These communication apparatuses may be configured to implement the functions of the first communication apparatus or the second communication apparatus in the foregoing method embodiments, and therefore can further implement the beneficial effect of the foregoing method embodiments.

As shown in FIG. 24, a communication apparatus 2400 includes a processing unit 2410 and an interface unit 2420. The interface unit 2420 may alternatively be a transceiver unit or an input/output interface. The communication apparatus 2400 may be configured to implement the functions of the first communication apparatus or the second communication apparatus in the method embodiment shown in FIG. 4, FIG. 11, FIG. 13, or FIG. 16.

When the communication apparatus 2400 is configured to implement the functions of the first communication apparatus in the method embodiment shown in FIG. 4, FIG. 11, FIG. 13, or FIG. 16:
the processing unit 2410 is configured to determine first information, where the first information includes configuration information of a first sensing signal; and
the interface unit 2420 is configured to send the first information and the first sensing signal, and receive a first measurement result, where the first measurement result is determined based on the first sensing signal, and the first measurement result is used for sensing.

In a possible design, the configuration information of the first sensing signal includes resource configuration information of the first sensing signal and/or sensing priority configuration information of the first sensing signal.

In a possible design, the resource configuration information of the first sensing signal includes one or more of the following: a beam relationship between the first sensing signal and a reference signal of a channel carrying the first information, an angle relationship between the first sensing signal and the reference signal corresponding to the channel carrying the first information, a QCL relationship between the first sensing signal and the reference signal of the channel carrying the first information, a subcarrier spacing configuration of the first sensing signal, a CP configuration of the first sensing signal, a time domain resource configuration of the first sensing signal, and a frequency domain resource configuration of the first sensing signal.

In a possible design, a time domain location of a first channel resource carrying the first information is earlier than a time domain location of a first signal resource carrying the first sensing signal, and/or a frequency domain resource length of the first channel resource carrying the first information is less than or equal to a frequency domain resource length of the first signal resource carrying the first sensing signal.

In a possible design, the first information further includes configuration information of a second channel resource, and the second channel resource is used for transmission of second information and/or third information, where the second information includes a measurement method and/or a measurement requirement for measuring the first sensing signal, the third information includes a measurement feedback configuration, and the measurement feedback configuration indicates a configuration for transmission of the first measurement result.

In a possible design, the measurement feedback configuration includes one or more of the following: a time domain resource range configuration for a measurement feedback, a frequency domain resource range configuration for a measurement feedback, and a measurement feedback content configuration.

In a possible design, the third information further includes first indication information and/or second indication information, where the first indication information indicates a second communication apparatus whether to send a second sensing signal, and the second indication information indicates the second communication apparatus whether to perform a measurement feedback on an echo signal of the second sensing signal sent by the second communication apparatus; and the second communication apparatus is an apparatus for determining the first measurement result based on the first sensing signal.

In a possible design, the interface unit 2420 is further configured to receive a third measurement result, where the third measurement result is determined by the second communication apparatus based on the echo signal of the second sensing signal sent by the second communication apparatus, and the first measurement result and the third measurement result are used together for sensing.

In a possible design, the first information further includes configuration information of a third channel resource and/or third indication information, where the third channel resource is used for transmission of a second measurement result, the second measurement result is determined by the processing unit 2410 based on an echo signal of the first sensing signal, and the third indication information indicates the interface unit 2420 whether to send the second measurement result.

In a possible design, the interface unit 2420 is further configured to receive first feedback information and the second sensing signal, where the first feedback information includes configuration information of the second sensing signal; and the processing unit 2410 is further configured to determine a fourth measurement result based on the second sensing signal, where the fourth measurement result and the first measurement result are used together for sensing.

In a possible design, there is a QCL relationship between the first sensing signal and the reference signal of the channel carrying the first information; or there is a QCL relationship between the first sensing signal and a sub-beam of the reference signal of the channel carrying the first information.

In a possible design, when an N-hop sensing signal measurement is performed, the third information further includes one or more of the following: a measurement hop count N, an N-hop measurement delay budget, and a current hop count, where N is greater than or equal to 2.

In a possible design, the interface unit 2420 is further configured to receive M fifth measurement results, where the first measurement result and the M fifth measurement results are used together for sensing. The first measurement result and the M fifth measurement results are determined by M+1 hop apparatuses; a measurement result determined by an O^{th}-hop apparatus in the M+1 hop apparatuses is determined based on a sensing signal sent by an (O−1)^{th}-hop apparatus, where O is greater than or equal to 2 and is less than or equal to M; and the first measurement result is determined by a first-hop apparatus in the M+1 hop apparatuses based on the first sensing signal sent by the interface unit 2420, where M is less than or equal to N.

In a possible design, a subcarrier spacing of the first sensing signal is 15*2\hat{ }n kHz, and a CP time ratio corresponding to the first sensing signal is 2/15; or a subcarrier spacing of the first sensing signal is (15+1)*2\hat{ }n kHz, and a cyclic prefix CP time ratio corresponding to the first sensing signal is 2/16, where n is an integer greater than or equal to 0.

In a possible design, the first information further includes duration of monitoring on a beam carrying the first sensing signal.

In a possible design, the interface unit 2420 is further configured to receive second feedback information, where the fifth information indicates feedback content corresponding to the first measurement result.

When the communication apparatus 2400 is configured to implement the functions of the second communication apparatus in the method embodiment shown in FIG. 4, FIG. 11, FIG. 13, or FIG. 16:
the interface unit 2420 is configured to receive first information and a first sensing signal, where the first information includes configuration information of the first sensing signal;
the processing unit 2410 is configured to determine a first measurement result based on the first sensing signal; and
the interface unit 2420 is further configured to send the first measurement result.

In a possible design, the configuration information of the first sensing signal includes resource configuration information of the first sensing signal and/or sensing priority configuration information of the first sensing signal.

In a possible design, the resource configuration information of the first sensing signal includes one or more of the following: a beam relationship between the first sensing signal and a reference signal of a channel carrying the first information, an angle relationship between the first sensing signal and the reference signal corresponding to the channel carrying the first information, a QCL relationship between the first sensing signal and the reference signal of the channel carrying the first information, a subcarrier spacing configuration of the first sensing signal, a cyclic prefix CP configuration of the first sensing signal, a time domain resource configuration of the first sensing signal, and a frequency domain resource configuration of the first sensing signal.

In a possible design, a time domain location of a first channel resource carrying the first information is earlier than a time domain location of a first signal resource carrying the first sensing signal, and/or a frequency domain resource length of the first channel resource carrying the first information is less than or equal to a frequency domain resource length of the first signal resource carrying the first sensing signal.

In a possible design, the first information further includes configuration information of a second channel resource, and the second channel resource is used for transmission of second information and/or third information, where the second information includes a measurement method and/or a measurement requirement for measuring the first sensing signal, the third information includes a measurement feedback configuration, and the measurement feedback configuration indicates a configuration for transmission of the first measurement result.

When the interface unit 2420 receives the second information on the second channel resource, the processing unit 2410 is specifically configured to determine the first measurement result based on the second information and the first sensing signal when determining the first measurement result based on the first sensing signal. When the interface unit 2420 receives the third information on the second channel resource, the interface unit 2420 is specifically configured to send the first measurement result based on the third information when sending the first measurement result.

In a possible design, the measurement feedback configuration includes one or more of the following: a time domain resource range configuration for a measurement feedback, a frequency domain resource range configuration for a measurement feedback, and a measurement feedback content configuration.

In a possible design, the interface unit 2420 is further configured to receive a second measurement result on a third channel resource, where the second measurement result is determined, based on an echo signal of the first sensing signal, by a first communication apparatus that sends the first sensing signal. The processing unit 2410 is specifically configured to determine the first measurement result based on the first sensing signal and the second measurement result when determining the first measurement result based on the first sensing signal.

In a possible design, the first information further includes configuration information of the third channel resource and/or third indication information, and the third indication information indicates the first communication apparatus whether to send the second measurement result.

In a possible design, the third information further includes first indication information, and the first indication information indicates whether to send a second sensing signal. When the first indication information indicates to send the second sensing signal, the interface unit 2420 sends first feedback information and the second sensing signal, where the first feedback information includes configuration information of the second sensing signal.

In a possible design, the third information further includes second indication information, and the second indication information indicates whether to perform a measurement feedback on an echo signal of the second sensing signal sent. When the second indication information indicates to perform the measurement feedback on the echo signal of the second sensing signal sent, the interface unit 2420 sends a third measurement result, where the third measurement result is determined by the processing unit 2410 based on the echo signal of the second sensing signal sent by the interface unit 2420.

In a possible design, there is a QCL relationship between the first sensing signal and the reference signal of the channel carrying the first information; or there is a QCL relationship between the first sensing signal and a sub-beam of the reference signal of the channel carrying the first information.

In a possible design, when an N-hop sensing signal measurement is performed, the third information further includes one or more of the following: a measurement hop count N, an N-hop measurement delay budget, and a current hop count, where N is greater than or equal to 2. The processing unit 2410 is further configured to determine a next-hop measurement feedback configuration based on the third information.

In a possible design, a subcarrier spacing of the first sensing signal is 15*2\hat{ }n kilohertz kHz, and a CP time ratio corresponding to the first sensing signal is 2/15; or a subcarrier spacing of the first sensing signal is (15+1)*2\hat{ }n kHz, and a CP time ratio corresponding to the first sensing signal is 2/16, where n is an integer greater than or equal to 0.

In a possible design, the first information further includes duration of monitoring on a beam carrying the first sensing signal.

In a possible design, the interface unit 2420 is further configured to send second feedback information, where the fifth information indicates feedback content corresponding to the first measurement result.

As shown in FIG. 25, this application further provides a communication apparatus 2500. The communication apparatus 2500 includes a processor 2510, and may further include a communication interface 2520. The processor 2510 and the communication interface 2520 are coupled to each other. It may be understood that the communication interface 2520 may be a transceiver, an input/output interface, an input interface, an output interface, an interface circuit, or the like. Optionally, the communication apparatus 2500 may further include a memory 2530, configured to store instructions executed by the processor 2510, or store input data required by the processor 2510 to run the instructions, or store data generated after the processor 2510 runs the instructions. The memory 2530 may be a physically independent unit, or may be coupled to the processor 2510, or the processor 2510 includes the memory 2530.

When the communication apparatus 2500 is configured to implement the method shown in FIG. 4, FIG. 11, FIG. 13, or FIG. 16, the processor 2510 may be configured to implement a function of the processing unit 2410, and the communication interface 2520 may be configured to implement a function of the interface unit 2420.

It may be understood that the processor in embodiments of this application may be a central processing unit (CPU), or may be another general-purpose processor, a digital signal processor (DSP), an application-specific integrated circuit (ASIC), a logic circuit, a field programmable gate array (FPGA) or another programmable logic device, a transistor logic device, a hardware component, or any combination thereof. The general-purpose processor may be a microprocessor or any conventional processor.

The method steps in embodiments of this application may be implemented in a hardware manner, or may be implemented in a manner of executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk drive, a removable hard disk, a CD-ROM, or any other form of storage medium well-known in the art. For example, a storage medium is coupled to a processor, so that the processor can read information from the storage medium and write information into the storage medium. Certainly, the storage medium may alternatively be a component of the processor. The processor and the storage medium may be disposed in an ASIC. In addition, the ASIC may be located in a network device or a terminal device. Certainly, the processor and the storage medium may alternatively exist as discrete components in a network device or a terminal device.

All or some of the foregoing embodiments may be implemented by using software, hardware, firmware, or any combination thereof. When software is used for implementation, all or some of embodiments may be implemented in a form of a computer program product. The computer program product includes one or more computer programs or instructions. When the computer programs or the instructions are loaded and executed on a computer, all or some of the procedures or functions in embodiments of this application are executed. The computer may be a general-purpose computer, a special-purpose computer, a computer network, a network device, user equipment, or another programmable apparatus. The computer programs or the instructions may be stored in a computer-readable storage medium, or may be transmitted from a computer-readable storage medium to another computer-readable storage medium. For example, the computer programs or the instructions may be transmitted from a network device, terminal, computer, server, or data center to another network device, terminal, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk drive, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

In addition, it should be understood that a word “for example” in embodiments of this application represents an example, an illustration, or a description. Any embodiment or design scheme described as an “example” in this application should not be explained as being more preferred or having more advantages than another embodiment or design scheme. Exactly, use of the word “example” is intended to present a concept in a specific manner.

It may be understood that various numbers in embodiments of this application are merely used for distinguishing for ease of description, and are not used to limit the scope of embodiments of this application. Sequence numbers of the foregoing processes do not mean an execution sequence, and the execution sequence of the processes should be determined based on functions and internal logic of the processes.

1. A sensing method, comprising:
sending, by a first communication apparatus, first information and a first sensing signal, wherein the first information comprises configuration information of the first sensing signal; and
receiving, by the first communication apparatus, a first measurement result, wherein the first measurement result is determined based on the first sensing signal, wherein
the first measurement result is used for sensing.

2. The method according to claim 1, wherein the configuration information of the first sensing signal comprises resource configuration information of the first sensing signal and/or sensing priority configuration information of the first sensing signal.

3. The method according to claim 2, wherein the resource configuration information of the first sensing signal comprises one or more of the following: a beam relationship between the first sensing signal and a reference signal of a channel carrying the first information, an angle relationship between the first sensing signal and the reference signal corresponding to the channel carrying the first information, a quasi co-location (QCL) relationship between the first sensing signal and the reference signal of the channel carrying the first information, a subcarrier spacing configuration of the first sensing signal, a cyclic prefix (CP) configuration of the first sensing signal, a time domain resource configuration of the first sensing signal, and a frequency domain resource configuration of the first sensing signal.

4. The method according to claim 1, wherein a time domain location of a first channel resource carrying the first information is earlier than a time domain location of a first signal resource carrying the first sensing signal, and/or a frequency domain resource length of the first channel resource carrying the first information is less than or equal to a frequency domain resource length of the first signal resource carrying the first sensing signal.

5. The method according to claim 1, wherein the first information further comprises configuration information of a second channel resource, and the second channel resource is used for transmission of second information and/or third information, wherein the second information comprises a measurement method and/or a measurement requirement for measuring the first sensing signal, the third information comprises a measurement feedback configuration, and the measurement feedback configuration indicates a configuration for transmission of the first measurement result.

6. The method according to claim 5, wherein the measurement feedback configuration comprises one or more of the following: a time domain resource range configuration for a measurement feedback, a frequency domain resource range configuration for a measurement feedback, and a measurement feedback content configuration.

7. The method according to claim 5, wherein the third information further comprises first indication information and/or second indication information, wherein the first indication information indicates a second communication apparatus whether to send a second sensing signal, and the second indication information indicates the second communication apparatus whether to perform a measurement feedback on an echo signal of the second sensing signal sent by the second communication apparatus; and the second communication apparatus is an apparatus for determining the first measurement result based on the first sensing signal.

8. The method according to claim 7, wherein the method further comprises:
receiving, by the first communication apparatus, a third measurement result, wherein the third measurement result is determined by the second communication apparatus based on the echo signal of the second sensing signal sent by the second communication apparatus, wherein
the first measurement result and the third measurement result are used together for sensing.

9. The method according to claim 1, wherein the first information further comprises configuration information of a third channel resource and/or third indication information, wherein the third channel resource is used for transmission of a second measurement result, the second measurement result is determined by the first communication apparatus based on an echo signal of the first sensing signal, and the third indication information indicates the first communication apparatus whether to send the second measurement result.

10. The method according to claim 1, wherein a subcarrier spacing of the first sensing signal is 15*2\hat{ }n kilohertz kHz, and a CP time ratio corresponding to the first sensing signal is 2/15; or
a subcarrier spacing of the first sensing signal is (15+1)*2\hat{ }n kHz, and a cyclic prefix CP time ratio corresponding to the first sensing signal is 2/16, wherein
n is an integer greater than or equal to 0.

11. A sensing method, comprising:
receiving, by a second communication apparatus, first information and a first sensing signal, wherein the first information comprises configuration information of the first sensing signal;
determining, by the second communication apparatus, a first measurement result based on the first sensing signal; and
sending, by the second communication apparatus, the first measurement result.

12. The method according to claim 11, wherein the configuration information of the first sensing signal comprises resource configuration information of the first sensing signal and/or sensing priority configuration information of the first sensing signal.

13. The method according to claim 12, wherein the resource configuration information of the first sensing signal comprises one or more of the following: a beam relationship between the first sensing signal and a reference signal of a channel carrying the first information, an angle relationship between the first sensing signal and the reference signal corresponding to the channel carrying the first information, a quasi co-location (QCL) relationship between the first sensing signal and the reference signal of the channel carrying the first information, a subcarrier spacing configuration of the first sensing signal, a cyclic prefix (CP) configuration of the first sensing signal, a time domain resource configuration of the first sensing signal, and a frequency domain resource configuration of the first sensing signal.

14. The method according to claim 11, wherein a time domain location of a first channel resource carrying the first information is earlier than a time domain location of a first signal resource carrying the first sensing signal, and/or a frequency domain resource length of the first channel resource carrying the first information is less than or equal to a frequency domain resource length of the first signal resource carrying the first sensing signal.

15. The method according to claim 11, wherein the first information further comprises configuration information of a second channel resource, and the second channel resource is used for transmission of second information and/or third information, wherein the second information comprises a measurement method and/or a measurement requirement for measuring the first sensing signal, the third information comprises a measurement feedback configuration, and the measurement feedback configuration indicates a configuration for transmission of the first measurement result;
when the second communication apparatus receives the second information on the second channel resource, determining, by the second communication apparatus, the first measurement result based on the first sensing signal comprises:
determining, by the second communication apparatus, the first measurement result based on the second information and the first sensing signal; and
when the second communication apparatus receives the third information on the second channel resource, sending, by the second communication apparatus, the first measurement result comprises:
sending, by the second communication apparatus, the first measurement result based on the third information.

16. The method according to claim 15, wherein the measurement feedback configuration comprises one or more of the following: a time domain resource range configuration for a measurement feedback, a frequency domain resource range configuration for a measurement feedback, and a measurement feedback content configuration.

17. The method according to claim 11, wherein the method further comprises:
receiving, by the second communication apparatus, a second measurement result on a third channel resource, wherein the second measurement result is determined, based on an echo signal of the first sensing signal, by a first communication apparatus that sends the first sensing signal; and
determining, by the second communication apparatus, the first measurement result based on the first sensing signal comprises:
determining, by the second communication apparatus, the first measurement result based on the first sensing signal and the second measurement result.

18. The method according to claim 17, wherein the first information further comprises configuration information of the third channel resource and/or third indication information, and the third indication information indicates the first communication apparatus whether to send the second measurement result.

19. The method according to claim 15, wherein the third information further comprises second indication information, and the second indication information indicates the second communication apparatus whether to perform a measurement feedback on an echo signal of the second sensing signal sent by the second communication apparatus; and the method further comprises:
when the second indication information indicates the second communication apparatus to perform the measurement feedback on the echo signal of the second sensing signal sent by the second communication apparatus, sending, by the second communication apparatus, a third measurement result, wherein the third measurement result is determined by the second communication apparatus based on the echo signal of the second sensing signal sent by the second communication apparatus.

20. A communication apparatus, comprising a processor, and
a non-transitory computer-readable storage medium coupled to the processor and storing programming instructions for execution by the processor, the programming instructions instruct the processor to: sending first information and a first sensing signal, wherein the first information comprises configuration information of the first sensing signal; and
receiving a first measurement result, wherein the first measurement result is determined based on the first sensing signal, wherein
the first measurement result is used for sensing.
